(19) United States
(12) Patent Application Publication
(10) Pub. No.: US 2026/0321216 A1
(43) Pub. Date: Oct. 15, 2026

(54) DISPLAY APPARATUS

(71) Applicant: SAMSUNG ELECTRONICS CO., LTD., Suwon-si (KR)

(72) Inventors: Hyukjun JANG, Suwon-si (KR); Hyesung HAN, Suwon-si (KR); Junsung CHOI, Suwon-si (KR); Chunsoon PARK, Suwon-si (KR); Hyungjin KIM, Suwon-si (KR); Taeyeon KIM, Suwon-si (KR); Sungyeol KIM, Suwon-si (KR); Daeyoung KIM, Suwon-si (KR)

(73) Assignee: SAMSUNG ELECTRONICS CO., LTD., Suwon-si (KR)

(21) Appl. No.: 19/538,179

(22) Filed: Feb. 12, 2026

Related U.S. Application Data
(63) Continuation of application No. PCT/KR2026/001506, filed on Jan. 26, 2026.

(30) Foreign Application Priority Data
Apr. 14, 2025 (KR) 10-2025-0048448

(51) Int. Cl. G09G 3/34

(52) U.S. Cl. CPC G09G 3/3406; G09G 2300/0452

(57) ABSTRACT

A display apparatus including: a backlight unit including a red LED, a green LED, and a blue LED; and a liquid crystal (LC) panel configured to transmit therethrough light emitted from the backlight unit, wherein the LC panel includes: a LC layer including independently controllable LC cells; a color filter layer on the LC layer and including a red filter, a green filter, a blue filter, and a transparent region; and one or more pixels, each of the one or more pixels including: a first sub-pixel including the red filter and a first LC cell of the LC cells; a second sub-pixel including the green filter and a second LC cell of the LC cells; a third sub-pixel including the blue filter and a third LC cell of the LC cells; and a fourth sub-pixel including the transparent region and a fourth LC cell of the LC cells.

### CROSS-REFERENCE TO RELATED APPLICATIONS

This application is a continuation of International Application No. PCT/KR2026/001506, filed on Jan. 26, 2026, which claims priority to Korean Patent Application No. 10-2025-0048448, filed on Apr. 14, 2025 in the Korean Intellectual Property Office, the disclosures of which are incorporated by reference herein in their entirety.

### 1. FIELD

The present disclosure relates to a display apparatus including a transparent sub-pixel.

### 2. DESCRIPTION OF RELATED ART

In general, a display apparatus converts acquired or stored electrical information into visual information to display the visual information for users. The display apparatus is widely used in various fields, such as at home or places of business.

The display apparatus may include a backlight unit (BLU) that provides light to a liquid crystal panel, and the backlight unit may include a plurality of light-emitting devices that may independently emit light. The light-emitting devices may include, for example, light-emitting diodes (LEDs) or organic light-emitting diodes (OLEDs).

Depending on the type of display apparatus, the backlight unit may include red LEDs, green LEDs, and blue LEDs.

### SUMMARY

According to one or more embodiments of the present disclosure, a display apparatus with improved light efficiency may be provided.

According to one or more embodiments of the present disclosure, a display apparatus that may minimize the number of light-emitting diodes (LEDs) may be provided.

According to one or more embodiments of the present disclosure, a display apparatus that may minimize the power consumption required to reproduce a specific luminance may be provided.

According to one or more embodiments of the present disclosure, a display apparatus with improved light uniformity may be provided.

Technical aspects that can be achieved by one or more embodiments of the present disclosure are not limited to the above-mentioned aspects, and other technical aspects not mentioned will be clearly understood by one of ordinary skill in the technical art to which the present disclosure belongs from the following description.

One or more embodiments of the present disclosure may provide a display apparatus including: a backlight unit including a red light-emitting diode (LED), a green LED, and a blue LED; and a liquid crystal panel configured to transmit therethrough light emitted from the backlight unit, wherein the liquid crystal panel includes: a liquid crystal layer including liquid crystal cells which are configured to be independently controlled; a color filter layer on the liquid crystal layer and including a red filter, a green filter, a blue filter, and a transparent region; and one or more pixels, each of the one or more pixels including: a first sub-pixel including the red filter and a first liquid crystal cell of the liquid crystal cells; a second sub-pixel including the green filter and a second liquid crystal cell of the liquid crystal cells; a third sub-pixel including the blue filter and a third liquid crystal cell of the liquid crystal cells; and a fourth sub-pixel including the transparent region and a fourth liquid crystal cell of the liquid crystal cells.

### BRIEF DESCRIPTION OF DRAWINGS

FIG. 1 illustrates an example of an appearance of a display apparatus according to one or more embodiments.

FIG. 2 illustrates an example of a configuration of a display apparatus according to one or more embodiments.

FIG. 3 illustrates an example of a liquid crystal panel included in a display apparatus according to one or more embodiments.

FIG. 4 illustrates an example of a backlight unit included in a display apparatus according to one or more embodiments.

FIG. 5 is a diagram illustrating that a plurality of light-emitting diodes (LEDs) of a backlight unit are divided into dimming blocks according to one or more embodiments.

FIG. 6 is a control block diagram of a display apparatus according to one or more embodiments.

FIG. 7 illustrates an example in which a display apparatus converts image data into dimming data according to one or more embodiments.

FIG. 8 illustrates an example of a light-emitting device included in a backlight unit according to one or more embodiments.

FIG. 9 illustrates another example of a light-emitting device included in a backlight unit according to one or more embodiments.

FIG. 10 illustrates an example of a configuration of a liquid crystal panel according to one or more embodiments.

FIGS. 11, 12, and 13 illustrate other examples of a configuration of a liquid crystal panel according to one or more embodiments.

FIG. 14 is a diagram illustrating operation of a liquid crystal panel when a light-emitting device outputs blue monochromatic light according to one or more embodiments.

FIG. 15 is a diagram illustrating operation of a liquid crystal panel when a light-emitting device outputs green monochromatic light according to one or more embodiments.

FIG. 16 is a diagram illustrating operation of a liquid crystal panel when a light-emitting device outputs red monochromatic light according to one or more embodiments.

FIG. 17 is a diagram illustrating operation of a liquid crystal panel when a light-emitting device outputs mixed light according to one or more embodiments.

### DETAILED DESCRIPTION

All of the embodiments of the disclosure described herein are example embodiments, and thus, the disclosure is not limited thereto, and may be realized in various other forms. Each of the embodiments provided in the following description is not excluded from being associated with one or more features of another example or another embodiment also provided herein or not provided herein but consistent with the disclosure.

It will be understood that when an element, component, layer, pattern, structure, region, or so on (hereinafter collectively “element”) of a semiconductor device is referred to as being “over,” “above,” “on,” “below,” “under,” “beneath,” “connected to” or “coupled to” another element of the semiconductor device, it can be directly over, above, on, below, under, beneath, connected or coupled to the other element or an intervening element(s) may be present. In contrast, when an element of a semiconductor device is referred to as being “directly over,” “directly above,” “directly on,” “directly below,” “directly under,” “directly beneath,” “directly connected to” or “directly coupled to” another element of the semiconductor device, there are no intervening elements present.

As used herein, the term “and/or” includes any and all combinations of one or more of the associated listed items. As used herein, expressions such as “at least one of,” when preceding a list of elements, modify the entire list of elements and do not modify the individual elements of the list. For example, the expression, “at least one of a, b and c,” and “at least one of a, b, or c” should be understood as including only a, only b, only c, both a and b, both a and c, both b and c, or all of a, b and c.

It will be also understood that, even if a certain step or operation of manufacturing an apparatus or structure is described later than another step or operation, the step or operation may be performed later than the other step or operation unless the other step or operation is described as being performed after the step or operation.

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In addition, the terms “portion”, “part”, “unit”, “module” or “member” may be implemented in hardware or software. Depending on the embodiments, a plurality of “portions”, “parts”, “units”, “modules” or “members” may be implemented as a single element, or a single “portion”, “part”, “unit”, “module” or “member” may include a plurality of elements.

It will be understood that, although the terms “first”, “second”, “third”, “primary”, “secondary”, “tertiary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

When an element (e.g., a first element) is referred to as being “(functionally or communicatively) coupled” or “connected” to another element (e.g., a second element), the first element may be connected to the second element, directly (e.g., wired), wirelessly, or through a third element.

In this disclosure, the terms “containing”, “including”, “comprising”, “having”, and the like are used to specify features, numbers, steps, operations, elements, components, or combinations thereof, but do not preclude the presence or addition of one or more of the features, numbers, steps, operations, elements, components, or combinations thereof.

In addition, in the present disclosure, the meaning of “identical” includes cases where properties are similar to each other or similar within a certain range. Furthermore, unless clearly indicated, stated, and/or shown otherwise; as used herein the terms “identical”, “uniform”, “equal”, and/or “the same” mean “substantially identical”, “substantially uniform”, “substantially equal”, “about the same”, and/or “substantially the same”. The meaning of substantially identical should be understood to include numerical values within manufacturing error ranges, machining or processing tolerances, and/or differences within a range that is so insignificant such that neither the structure nor function of the embodiments disclosed herein are materially altered, inhibited, or destroyed.

Unless otherwise indicated, as used herein with regard to any plurality of a particular type of component, any two components of that type are considered “adjacent” or “adjacent to” one another so long as no other component of that type occupies a space between the two components. That is, the two components are considered adjacent each other if the two components are not separated from each other by an intervening component of that type.

Furthermore, although one or more embodiments may comprise the disclosed features as described herein—as well as additional features not specifically described—other embodiments may instead be completely free of non-disclosed elements. For example, non-disclosed elements may be completely omitted from one or more embodiments of the present disclosure.

As used herein, the terms “front (or forward)”, “rear (or back, backward, rearward)”, “up (or upper, top, above)”, “down (or lower, bottom, below)”, “left”, “right”, and the like may be defined with reference to the drawings, and may not be intended to limit the shape and/or position of each component.

Hereinafter, embodiments of the present disclosure will be described in detail with reference to the accompanying drawings.

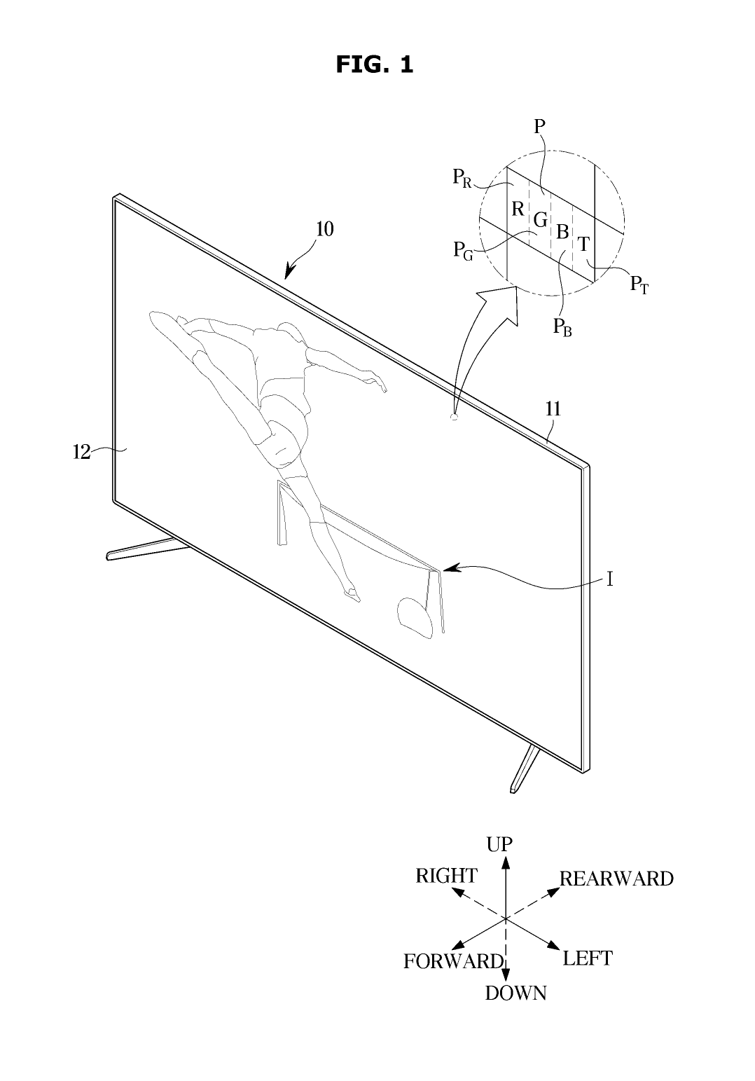

FIG. 1 illustrates an example of an appearance of a display apparatus according to one or more embodiments.

Referring to FIG. 1, a display apparatus 10 is a device capable of processing an image signal received from the outside and visually displaying a processed image. Hereinafter, a case in which the display apparatus 10 is a television (TV) is exemplified, but is not limited thereto. For example, the display apparatus 10 may be implemented in various forms, such as a monitor, a portable multimedia device, a portable communication device, and the like, and the form of the display apparatus 10 is not limited as long as it is a device that visually displays an image.

In addition, the display apparatus 10 may be a large format display (LFD) installed outdoors, such as a building rooftop or a bus stop. Here, the outdoors is not necessarily limited to an outdoor space, and the display apparatus 10 according to one or more embodiments may be installed wherever a large number of people may come and go, even indoors such as at subway stations, shopping malls, movie theaters, office buildings, and stores.

The display apparatus 10 may receive content including a video signal and an audio signal from various content sources, and output video and audio corresponding to the video signal and the audio signal, respectively. For example, the display apparatus 10 may receive content data through a broadcast reception antenna or a wired cable, receive content data from a content playback apparatus, or receive content data from a content-providing server of a content provider.

As shown in FIG. 1, the display apparatus 10 may include a main body 11 and a screen 12 for displaying an image I.

The main body 11 forms an exterior of the display apparatus 10, and components for the display apparatus 10 to display the image I or perform various functions may be provided inside the main body 11. The main body 11 shown in FIG. 1 has a flat plate shape, but the shape of the main body 11 is not limited to that shown in FIG. 1. For example, the main body 11 may have a curved plate shape.

The screen 12 is formed on a front surface of the main body 11, and may display the image I. For example, the screen 12 may display a still image or a video. In addition, the screen 12 may display a two-dimensional plane image or a three-dimensional stereoscopic image using binocular parallax of a user.

The screen 12 may include a liquid crystal panel capable of transmitting or blocking light emitted by a backlight unit (BLU), or the like.

A plurality of pixels P may be formed on the screen 12, and the image I displayed on the screen 12 may be formed by light emitted from each of the plurality of pixels P. For example, the image I may be formed on the screen 12 by combining light emitted from each of the plurality of pixels P like a mosaic.

Each of the plurality of pixels P may emit light of various brightness and various colors. In order to emit light of various colors, each of the plurality of pixels P may include sub-pixels PR, PG, PB, and PT.

The sub-pixels PR, PG, PB, and PT may include a red sub-pixel PR capable of selectively emitting red light, a green sub-pixel PG capable of selectively emitting green light, a blue sub-pixel PB capable of selectively emitting blue light, and a transparent sub-pixel PT capable of selectively emitting red light, blue light, and green light. For example, the red light may represent light having a wavelength of approximately 700 nm (nanometer, one billionth of a meter) to 800 nm. The green light may represent light having a wavelength of approximately 500 nm to 600 nm. The blue light may represent light having a wavelength of approximately 400 nm to 500 nm.

By combining the red light of the red sub-pixel PR, the green light of the green sub-pixel PG, the blue light of the blue sub-pixel PB, and the monochromatic light or mixed light of the transparent sub-pixel PT, light of various brightness and various colors may be emitted from each of the plurality of pixels P.

In the present disclosure, mixed light may refer to light in which at least two of red light, green light, and blue light are mixed, and monochromatic light may refer to each of red light, green light, and blue light.

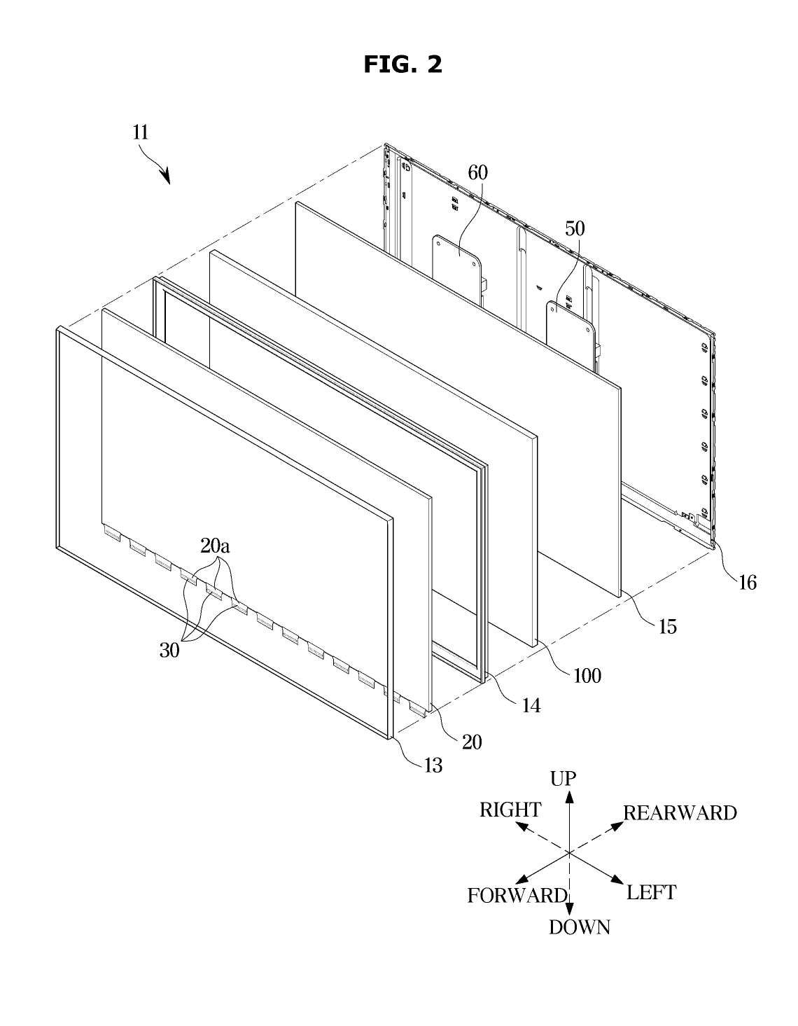

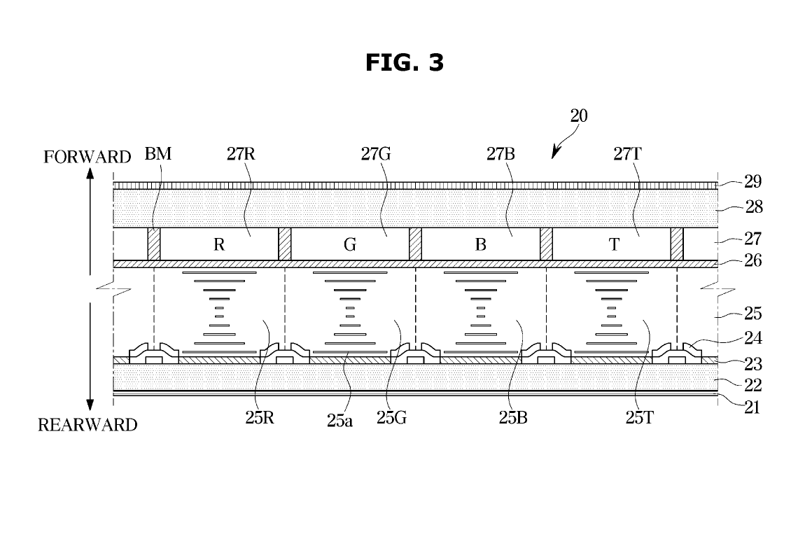

FIG. 2 illustrates an example of a configuration of a display apparatus according to one or more embodiments, and FIG. 3 illustrates an example of a liquid crystal panel included in a display apparatus according to one or more embodiments.

As shown in FIG. 2, various components for generating an image I on the screen 12 may be provided in the main body 11.

For example, the main body 11 may include a backlight unit 100 which is a surface light source, a liquid crystal panel 20 blocking or transmitting light emitted from the backlight unit 100, a control assembly 50 controlling operations of the backlight unit 100 and the liquid crystal panel 20, and a power assembly 60 supplying power to the backlight unit 100 and the liquid crystal panel 20. In addition, the main body 11 may include a bezel 13, a frame middle mold 14, a bottom chassis 15, and a rear cover 16 for supporting the liquid crystal panel 20, the backlight unit 100, the control assembly 50, and the power assembly 60.

The backlight unit 100 may include a point light source that emits mixed light (or white light). In addition, the backlight unit 100 may refract, reflect, and scatter the light to convert the light emitted from the point light source into a uniform surface light. As described above, the backlight unit 100 may refract, reflect, and scatter the light emitted from the point light source to emit a uniform surface light in a forward direction.

The backlight unit 100 may also be referred to as the light source apparatus 100 in that the backlight unit 100 is a component for outputting light.

The backlight unit 100 will be described in more detail below.

The liquid crystal panel 20 is provided in front of the backlight unit 100, and blocks or transmits light emitted from the backlight unit 100 to form the image I.

A front surface of the liquid crystal panel 20 forms the screen 12 of the display apparatus 10 described above, and the liquid crystal panel 20 may form the plurality of pixels P. The plurality of pixels P of the liquid crystal panel 20 may independently block or transmit the light of the backlight unit 100. In addition, the light transmitted by the plurality of pixels P may form the image I to be displayed on the screen 12.

For example, as shown in FIG. 3, the liquid crystal panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The color filter 27 may be provided on the second transparent substrate 28. For example, the color filter 27 may be provided on the front surface of the second transparent substrate 28 or on the rear surface of the second transparent substrate 28.

A layer formed by arranging the color filter 27 on the second transparent substrate 28 may be referred to as color filter layers 27 and 28.

The first transparent substrate 22 and the second transparent substrate 28 may fixedly support the pixel electrode 23, the thin film transistor 24, the liquid crystal layer 25, the common electrode 26, and the color filter 27. The first transparent substrate 22 and the second transparent substrate 28 may be formed of tempered glass or transparent resin. For example, the first transparent substrate 22 and the second transparent substrate 28 may be referred to as a glass substrate.

The first polarizing film 21 and the second polarizing film 29 are provided on outer sides of the first transparent substrate 22 and the second transparent substrate 28 . The first polarizing film 21 and the second polarizing film 29 may each transmit specific polarized light and block (reflect or absorb) the other polarized light. For example, the first polarizing film 21 may transmit light polarized in a first direction and block (reflect or absorb) the other polarized light. In addition, the second polarizing film 29 may transmit light polarized in a second direction and block (reflect or absorb) the other polarized light. In this instance, the first direction and the second direction may be orthogonal to each other. Thus, the polarized light passing through the first polarizing film 21 may not directly pass through the second polarizing film 29.

The color filter 27 may include, for example, a red filter 27R transmitting red light, a green filter 27G transmitting green light, and a blue filter 27B transmitting blue light.

The color filter 27 may be an absorption filter that transmits a specific wavelength band of incident light and absorbs the remaining wavelength band.

For example, the red filter 27R may transmit light in the wavelength band from 700 nm to 800 nm and absorb light in the remaining wavelength band.

The green filter 27G may transmit light in the wavelength band from 500 nm to 600 nm and absorb light in the remaining wavelength band.

The blue filter 27B may transmit light in the wavelength band from 400 nm to 500 nm and absorb light in the remaining wavelength band.

The color filter 27 may be distinguished from quantum dots that absorb incident light and then emit light of a specific wavelength. Accordingly, the color filter layers 27 and 28 are different from the quantum dot sheet.

In one or more embodiments, the color filter layers 27 and 28 include the red filter 27R, the green filter 27G, and the blue filter 27B disposed on the second transparent substrate 28, and may include a transparent region 27T on the second transparent substrate 28 where the red filter 27R, the green filter 27G, and the blue filter 27B are not formed.

The transparent region 27T may refer to a region on the second transparent substrate 28 where the red filter 27R, the green filter 27G, and the blue filter 27B are not formed.

According to various embodiments, a light diffusion member may be disposed on the transparent region 27T.

In the present disclosure, the transparent region 27T may be referred to as the transparent filter 27T in that the transparent region 27T transmits all incident light.

In one or more embodiments, the red filter 27R, the green filter 27G, the blue filter 27B, and the transparent filter 27T may be partitioned by a black matrix BM.

According to one or more embodiments of the present disclosure, the color filter layers 27 and 28 include the transparent filter 27T, thereby improving light efficiency.

The red filter 27R, the green filter 27G, the blue filter 27B, and the transparent filter 27T may be arranged side by side. The arrangement order of the red filter 27R, the green filter 27G, the blue filter 27B, and the transparent filter 27T may vary.

A region occupied by the color filter 27 and the transparent filter 27T corresponds to the pixel P described above. A region occupied by the red filter 27R corresponds to the red sub-pixel PR, a region occupied by the green filter 27G corresponds to the green sub-pixel PG, a region occupied by the blue filter 27B corresponds to the blue sub-pixel PB, and a region occupied by the transparent filter 27T corresponds to the transparent sub-pixel PT.

The black matrix BM may define boundaries between each sub-pixel PR, PG, PB, and PT. The width of each sub-pixel PR, PG, PB, and PT may correspond to the width of each cell of the black matrix BM.

The red sub-pixel PR, the green sub-pixel PG, the blue sub-pixel PB, and the transparent sub-pixel PT may form a single pixel P.

The liquid crystal panel 20 may include a plurality of pixels P each including the red sub-pixel PR, the green sub-pixel PG, the blue sub-pixel PB, and the transparent sub-pixel PT.

Each of the red sub-pixel PR, the green sub-pixel PG, the blue sub-pixel PB, and the transparent sub-pixel PT may be independently controlled.

The pixel electrode 23 may be provided on an inner side of the first transparent substrate 22, and the common electrode 26 may be provided on the inner side of the second transparent substrate 28. The pixel electrode 23 and the common electrode 26 are formed of a metal material through which electricity is conducted, and may generate an electric field for changing the arrangement of liquid crystal molecules 25a constituting the liquid crystal layer 25 to be described below.

The thin film transistor (TFT) 24 is provided on the inner side of the transparent substrates 22 and 28. The TFT 24 may be turned on (closed) or off (opened) by image data provided from a panel driver 30. In addition, by turning the TFT 24 on (closing) or off (opening), an electric field may be formed or removed from between the pixel electrode 23 and the common electrode 26.

The liquid crystal layer 25 is formed between the pixel electrode 23 and the common electrode 26, and is filled with liquid crystal molecules 25a. The liquid crystal may represent an intermediate state between a solid (crystal) and a liquid. The liquid crystal may exhibit optical properties depending on a change in electric field. For example, a direction of the molecular arrangement constituting the liquid crystal may change depending on a change in electric field. As a result, optical properties of the liquid crystal layer 25 may change according to the presence or absence of the electric field passing through the liquid crystal layer 25. For example, the liquid crystal layer 25 may rotate a polarization direction of light about an optical axis according to the presence or absence of the electric field. Accordingly, the polarized light that has passed through the first polarizing film 21 is changed in polarization direction while passing through the liquid crystal layer 25, and may pass through the second polarizing film 29.

The liquid crystal layer 25 may include a plurality of independently controllable liquid crystal cells. Each of the plurality of liquid crystal cells may be independently controlled by the TFT 24.

In the present disclosure, a liquid crystal cell may refer to a portion of the liquid crystal layer 25 that is independently controllable by the TFT 24.

Each of the plurality of liquid crystal cells may be aligned with the red filter 27R, the green filter 27G, the blue filter 27B, and the transparent filter 27T.

For example, the plurality of liquid crystal cells may include a first liquid crystal cell 25R aligned with the red filter 27R, a second liquid crystal cell 25G aligned with the green filter 27G, a third liquid crystal cell 25B aligned with the blue filter 27B, and a fourth liquid crystal cell 25T aligned with the transparent filter 27T.

Each of the plurality of liquid crystal cells 25R, 25G, 25B, and 25T may be controlled by a corresponding TFT 24.

The red sub-pixel PR may be formed by aligning the red filter 27R and the first liquid crystal cell 25R, the green sub-pixel PG may be formed by aligning the green filter 27G and the second liquid crystal cell 25G, the blue sub-pixel PB may be formed by aligning the blue filter 27B and the third liquid crystal cell 25B, and the transparent sub-pixel PT may be formed by aligning the transparent filter 27T and the fourth liquid crystal cell 25T.

An opening degree of each of the red sub-pixel PR, the green sub-pixel PG, the blue sub-pixel PB, and the transparent sub-pixel PT may be independently controlled depending on whether the corresponding TFT 24 is turned on (closed) or turned off (open).

At one edge of the liquid crystal panel 20, a cable 20a through which image data is transmitted to the liquid crystal panel 20 and a display driver integrated circuit (DDI) 30 (hereinafter, referred to as the “panel driver”) that processes digital image data and outputs an analog image signal may be provided.

The cable 20a may electrically connect between the control assembly 50/the power assembly 60 and the panel driver 30, and may also electrically connect the panel driver 30 and the liquid crystal panel 20. The cable 20a may include a flexible flat cable or a film cable that may be bendable.

The panel driver 30 may receive image data and power from the control assembly 50/the power assembly 60 through the cable 20a. Further, the panel driver 30 may provide image data and driving current to the liquid crystal panel 20 through the cable 20a.

In addition, the cable 20a and the panel driver 30 may be integrally implemented as a film cable, a chip on film (COF), a tape carrier packet (TCP), or the like. In other words, the panel driver 30 may be disposed on the cable 20a. However, the present disclosure is not limited thereto, and the panel driver 30 may be disposed on the liquid crystal panel 20.

The control assembly 50 may include a control circuit that controls operations of the liquid crystal panel 20 and the backlight unit 100. For example, the control circuit may process a video signal and/or an audio signal received from an external content source. The control circuit may transmit the image data to the liquid crystal panel 20, and may transmit dimming data to the backlight unit 100.

The power assembly 60 may include a power circuit supplying power to the liquid crystal panel 20 and the backlight unit 100. The power circuit may supply power to the control assembly 50, the backlight unit 100, and the liquid crystal panel 20.

The control assembly 50 and the power assembly 60 may be implemented with a printed circuit board and various circuits mounted on the printed circuit board. For example, the power circuit may include a condenser, a coil, a resistance element, a processor, and the like and a power circuit board on which these elements are mounted. In addition, the control circuit may include a memory, a processor, and a control circuit board on which these elements are mounted.

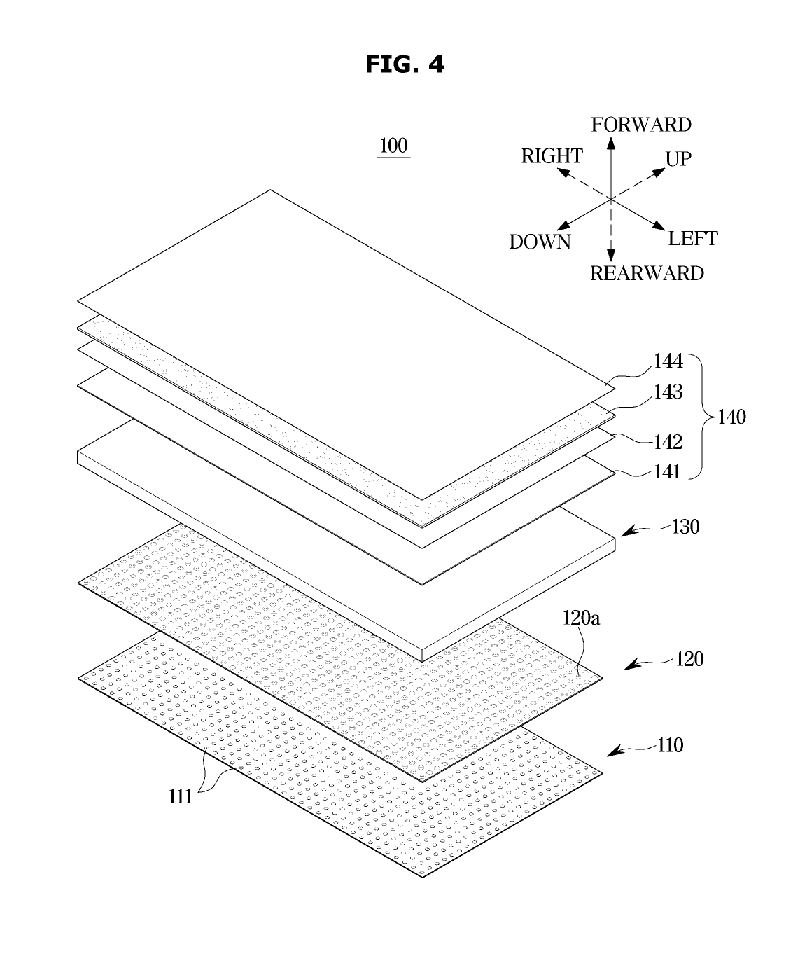

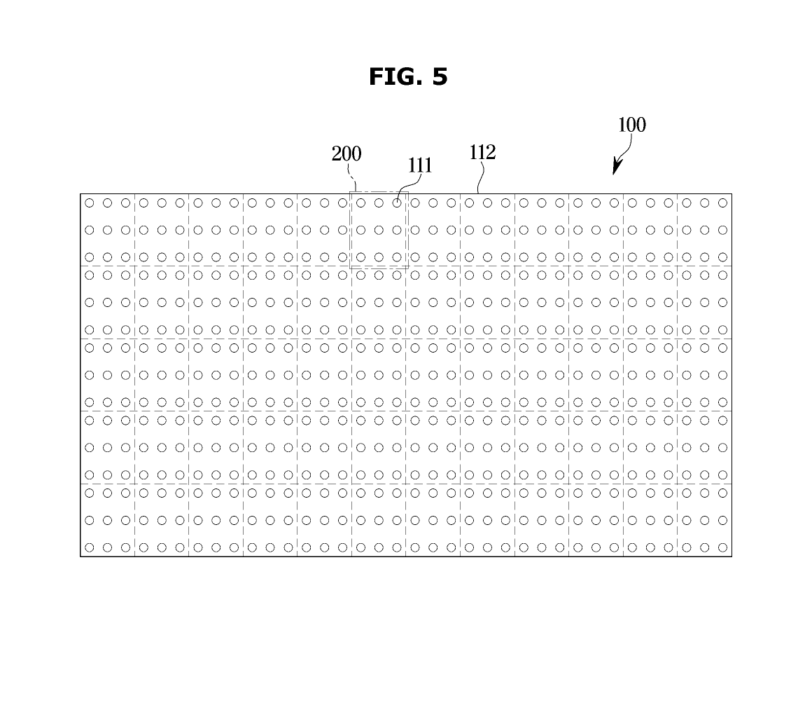

FIG. 4 illustrates an example of the backlight unit 100 included in the display apparatus 10, and FIG. 5 is a diagram illustrating that a plurality of LEDs of the backlight unit 100 are divided into dimming blocks according to one or more embodiments.

As shown in FIG. 4, the backlight unit 100 may include a light source module 110 generating light, a reflector sheet 120 reflecting light, a diffuser plate 130 uniformly diffusing light, and an optical sheet 140 improving luminance of the output light.

The light source module 110 may include a plurality of light-emitting devices 111 emitting light, and a substrate 112 supporting/fixing the plurality of light-emitting devices 111.

The plurality of light-emitting devices 111 may be arranged in a predetermined pattern to allow light to be emitted with uniform luminance. The plurality of light-emitting devices 111 may be arranged to allow a distance between a single light source and each light source adjacent thereto to be the same.

For example, as shown in FIG. 4, the plurality of light-emitting devices 111 may be aligned in rows and columns. For example, the plurality of light sources may be arranged to form an approximate square by four adjacent light sources. In addition, any one light source is disposed adjacent to four light sources, and a distance between the single light source and each of the four light sources adjacent to the single light source may be substantially the same.

Furthermore, according to embodiments, the plurality of light sources may be arranged such that three adjacent light sources form a substantially equilateral triangle. In this case, a single light source may be disposed adjacent to six light sources. In addition, a distance between the single light source and each of the six adjacent light sources may be substantially the same.

However, the arrangement of the plurality of light-emitting devices 111 is not limited to the arrangement described above, and the plurality of light-emitting devices 111 may be disposed in various patterns to allow light to be emitted with uniform luminance.

Each light-emitting device 111 may employ a device capable of emitting monochromatic light (light having a specific range of wavelengths, for example, blue light) or white light (for example, mixed light of red light, green light, and blue light) in various directions when power is supplied. For example, the light-emitting device 111 may include an LED. The LED may be implemented in a variety of sizes and may include, for example, mini LEDs and/or micro LEDs.

The substrate 112 may fix the plurality of light-emitting devices 111 to prevent positions of the light-emitting devices 111 from being changed. In addition, the substrate 112 may supply power for enabling the light-emitting devices 111 to emit light to the individual light-emitting devices 111.

The substrate 112 may fix the plurality of light-emitting devices 111, and may include a synthetic resin and/or tempered glass and/or a printed circuit board (PCB) on which a conductive power feed line for supplying power to the light-emitting device 111 is formed.

The reflector sheet 120 may reflect light emitted from the plurality of light-emitting devices 111 in a forward direction or in a direction close to the forward direction.

A plurality of through holes 120a corresponding respectively to the plurality of light-emitting devices 111 of the light source module 110 are formed in the reflector sheet 120. In addition, the light-emitting devices 111 of the light source module 110 may pass through the through holes 120a and protrude forward of the reflector sheet 120.

For example, in an assembly process of the reflector sheet 120 and the light source module 110, the plurality of light-emitting devices 111 of the light source module 110 are inserted into the plurality of through holes 120a formed in the reflector sheet 120. As a result, the substrate 112 of the light source module 110 is located behind the reflector sheet 120, but the plurality of light-emitting devices 111 of the light source module 110 may be located in front of the reflector sheet 120.

Accordingly, the plurality of light-emitting devices 111 may emit light in front of the reflector sheet 120.

The plurality of light-emitting devices 111 may emit light in front of the reflector sheet 120 in various directions. Light may be emitted from the light-emitting device 111 not only toward the diffuser plate 130, but also toward the reflector sheet 120, and the reflector sheet 120 may reflect the light emitted toward the reflector sheet 120 toward the diffuser plate 130.

The light emitted from the light-emitting device 111 passes through various objects such as the diffuser plate 130 and the optical sheet 140. When the light passes the diffuser plate 130 and the optical sheet 140, a portion of the incident light is reflected from surfaces of the diffuser plate 130 and the optical sheet 140. The reflector sheet 120 may reflect the light reflected by the diffuser plate 130 and the optical sheet 140.

The diffuser plate 130 may be disposed in front of the light source module 110 and the reflector sheet 120, and may uniformly disperse the light emitted from the light-emitting device 111 of the light source module 110.

As described above, the plurality of light-emitting devices 111 are located at various positions on a rear surface of the backlight unit 100. Although the plurality of light-emitting devices 111 are equidistantly arranged on the rear surface of the backlight unit 100, non-uniformity of luminance may exist depending on the positions of the plurality of light-emitting devices 111.

To eliminate the non-uniformity of luminance due to the plurality of light-emitting devices 111, the diffuser plate 130 may diffuse the light emitted from the plurality of light-emitting devices 111 within the diffuser plate 130. In other words, the diffuser plate 130 may uniformly emit non-uniform light from the plurality of light-emitting devices 111 to the front surface.

The optical sheet 140 may include various sheets for improving luminance and luminance uniformity. For example, the optical sheet 140 may include a diffuser sheet 141, a first prism sheet 142, a second prism sheet 143, a reflective polarizing sheet 144, and the like.

The diffuser sheet 141 diffuses light for uniformity of luminance. The light emitted from the light-emitting device 111 is diffused by the diffuser plate 130, and may be diffused again by the diffuser sheet 141 included in the optical sheet 140.

The first prism sheet 142 and the second prism sheet 143 may concentrate the light diffused by the diffuser sheet 141, thereby increasing the luminance. The first prism sheet 142 and the second prism sheet 143 include a prism pattern of a triangular prism shape, and a plurality of these prism patterns are arranged adjacent to each other to form a plurality of bands.

The reflective polarizing sheet 144 is a kind of polarizing film, and may transmit a portion of the incident light, and reflect other portions to improve luminance. For example, the reflective polarizing sheet 144 may transmit light polarized in the same direction as a predetermined polarization direction of the reflective polarizing sheet 144 and reflect light polarized in a different direction from the polarization direction of the reflective polarizing sheet 144. In addition, the light reflected by the reflective polarizing sheet 144 is reused within the backlight unit 100, and the luminance of the display apparatus 10 may be improved by such light recycle.

The optical sheet 140 is not limited to the sheets or films shown in FIG. 4, and may further include more various sheets or films such as protective sheets.

The backlight unit 100 includes the plurality of light-emitting devices (light sources) 111, and may output surface light by diffusing the light emitted from the plurality of light sources 111. The liquid crystal panel 20 includes a plurality of pixels, and may control the plurality of pixels to allow each of the plurality of pixels to transmit or block light. An image may be formed by light passing through each of the plurality of pixels.

In this instance, the display apparatus 10 may perform local dimming to vary a brightness of light for each region of the backlight unit 100 in association with the output image to improve power consumption while increasing a contrast ratio.

For example, the display apparatus 10 may reduce the brightness of light of the light-emitting device 111 of the backlight unit 100 corresponding to a dark portion of an image to make the dark portion of the image darker, and may increase the brightness of light of the light-emitting device 111 of the backlight unit 100 corresponding to a bright portion of the image to make the bright portion of the image brighter. As a result, a contrast ratio or a brightness ratio of the image may be improved.

The display apparatus 10 may divide the backlight unit 100 into a plurality of blocks, and adjust current independently for each block according to an input image. Image transmission of the display apparatus 10 is performed through a method of frame-by-frame local dimming drives, and the driving of the current is adjusted according to the number of divided blocks of the light-emitting devices 111 in the backlight unit 100.

As a result, the display apparatus 10 may effectively improve a contrast ratio by lowering a supply current to the dimming blocks of regions where the input image is dark and increasing the supply current to the dimming blocks of regions where the input image is bright.

For local dimming, the plurality of light-emitting devices 111 included in the backlight unit 100 may be divided into a plurality of dimming blocks 200. For example, the plurality of dimming blocks 200 may be provided as a total of 60 blocks, composed of five rows and twelve columns, as shown in FIG. 5. As another example, the plurality of dimming blocks 200 may be provided as a total of 20 blocks, composed of five rows and four columns. However, the number of dimming blocks 200 is not limited to the above examples.

Referring to FIG. 5, each of the plurality of dimming blocks 200 may include at least one light-emitting device 111. The backlight unit 100 may supply the same driving current to the light-emitting devices 111 belonging to the same dimming block 200, and the light-emitting devices 111 belonging to the same dimming block 200 may emit light of the same brightness.

In addition, the backlight unit 100 may supply different driving currents to the light-emitting devices 111 belonging to different dimming blocks 200 according to dimming data, and the light-emitting devices 111 belonging to different dimming blocks 200 may emit light of different brightness.

As will be described below, among the light-emitting devices 111 belonging to the same dimming block 200, different driving currents may be supplied to light-emitting diodes (LEDs) that output light of different colors, and the same driving current may be supplied to LEDs that output light of the same color. To this end, dimming data corresponding to one dimming block may include RGB color values.

For example, each of the plurality of dimming blocks 200 may include N*M light sources arranged in an N*M matrix form (N and M are natural numbers). The N*M matrix refers to a matrix with N rows and M columns.

Because each of the light-emitting devices 111 includes an LED, each of the plurality of dimming blocks 200 may include N*M LEDs. That is, each of the plurality of dimming blocks 200 may include a predetermined number of light-emitting devices 111.

The plurality of dimming blocks 200 may be arranged on the substrate 112. That is, N*M LEDs may be disposed on the substrate 112.

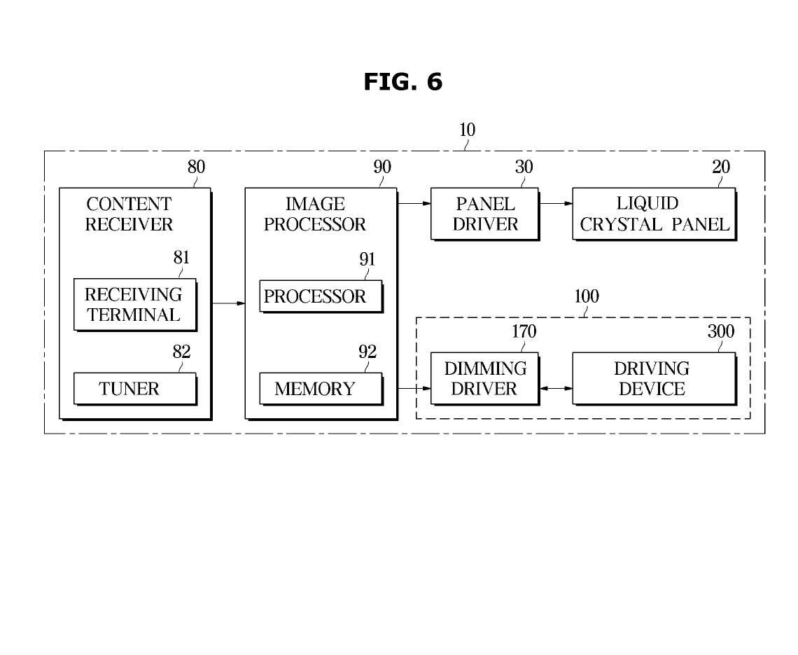

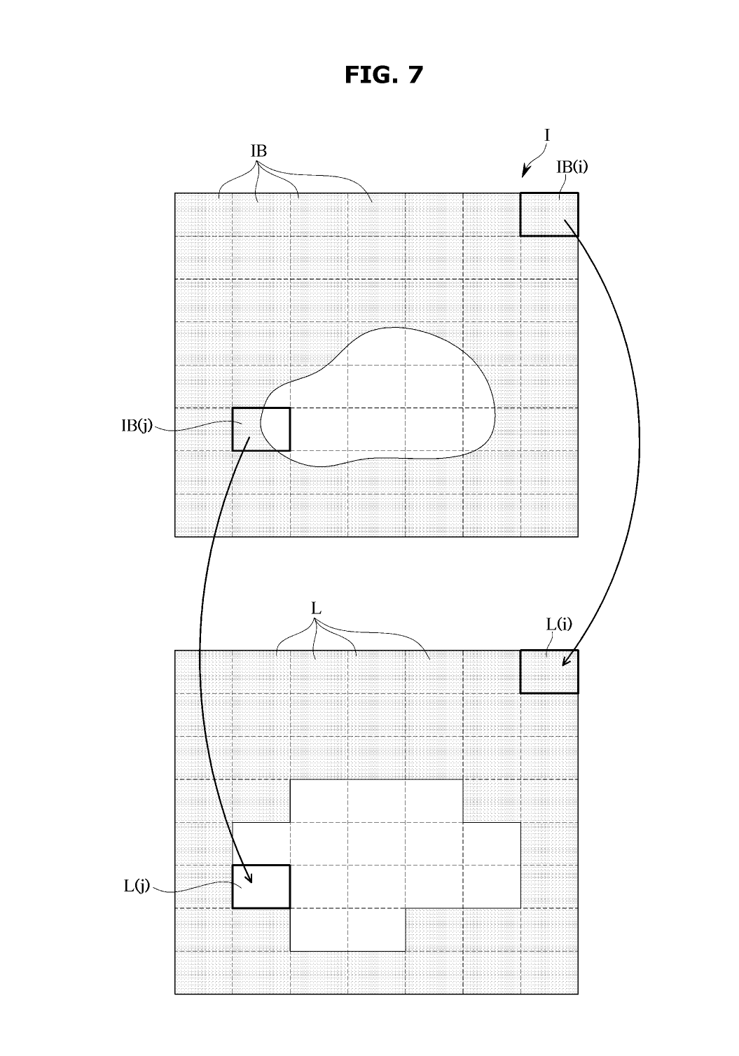

FIG. 6 is a control block diagram of a display apparatus according to one or more embodiments, and FIG. 7 illustrates an example in which a display apparatus converts image data into dimming data according to one or more embodiments.

Referring to FIG. 6, the display apparatus 10 may include a content receiver 80, an image processor 90, the panel driver 30, the liquid crystal panel 20, and the backlight unit 100. In this instance, the backlight unit 100 may include a dimming driver 170 that performs local dimming and a driving device 300 that drives the light-emitting device 111. The driving device 300 may be disposed on an upper surface or a lower surface of the substrate 112.

The content receiver 80 may include a receiving terminal 81 receiving content including a video signal and/or audio signal from content sources, and a tuner 82.

The receiving terminal 81 may receive a video signal and audio signal from content sources through a cable. For example, the receiving terminal 81 may include a component (YPbPr/RGB) terminal, a composite video blanking and sync (CVBS) terminal, an audio terminal, a high definition multimedia interface (HDMI) terminal, a universal serial bus (USB) terminal, and the like.

The tuner 82 may receive a broadcast signal from a broadcast reception antenna or a wired cable, and may extract a broadcast signal of a channel selected by a user from among broadcast signals. For example, the tuner 82 may pass a broadcast signal having a frequency corresponding to the channel selected by the user among a plurality of broadcast signals received through the broadcast reception antenna or wired cable, and may block a broadcast signal having a different frequency.

As described above, the content receiver 80 may receive an image including a video signal and an audio signal from the content sources through the receiving terminal 81 and/or the tuner 82, and may output the input image received through the receiving terminal 81 and/or the tuner 82 to the image processor 90.

The image processor 90 may include at least one processor 91 that processes an input image (image data) and a memory 92 that records/stores data.

The memory 92 stores programs and data for processing a video signal and/or an audio signal, and may temporarily remember data generated while processing the video signal and/or audio signal.

The memory 92 may include a non-volatile memory, such as read only memory (ROM) and flash memory, and a volatile memory, such as static random access memory (S-RAM) and dynamic random access memory (D-RAM).

The at least one processor 91 may receive an input image including a video signal and/or an audio signal from the content receiver 80, may decode the video signal into image data, and may generate dimming data from the image data. The image data and the dimming data may be output to the panel driver 30 and the dimming driver 170, respectively.

The at least one processor 91 may provide dimming data for local dimming to the backlight unit 100. The dimming data may include information about a luminance of each of the plurality of dimming blocks 200. For example, the dimming data may include information about an intensity of light output by the light-emitting devices 111 included in each of the plurality of dimming blocks 200. That is, the dimming data may include information about a magnitude of current supplied to the light-emitting devices 111 included in each of the plurality of dimming blocks 200.

The dimming data may include information about the magnitude of current supplied to each of the red LED 190R, the green LED 190G, and the blue LED 190B included in the light-emitting device 111 included in each of the plurality of dimming blocks 200.

The at least one processor 91 may calculate an average of RGB color values of each of the plurality of dimming blocks 200 based on the image data, and may generate dimming data of each of the plurality of dimming blocks 200 based on the average of the RGB color values.

The at least one processor 91 may obtain the dimming data from the image data decoded from the video signal.

The processor 91 may convert the image data into the dimming data in various manners. For example, as shown in FIG. 7, the processor 91 may divide an image I based on the image data into a plurality of image blocks IB. The number of the plurality of image blocks IB is equal to the number of the plurality of dimming blocks 200, and the plurality of image blocks IB may each correspond to the plurality of dimming blocks 200.

The processor 91 may obtain luminance values L of the plurality of dimming blocks 200 from the image data of the plurality of image blocks IB. The luminance values L of the plurality of dimming blocks 200 may include RGB color values of the plurality of dimming blocks 200.

The processor 91 may generate the dimming data by combining the luminance values L of the plurality of dimming blocks 200.

For example, the processor 91 may obtain a luminance value L of each of the plurality of dimming blocks 200 based on a maximum value among luminance values of pixels included in each of the image blocks IB.

A single image block includes a plurality of pixels P, and image data of a single image block may include image data of a plurality of pixels P (e.g., red data, green data, blue data, etc.). The processor 91 may calculate the luminance value of each of the pixels based on the image data of each of the pixels.

The image data may include a red data value corresponding to the red data, a green data value corresponding to the green data, and a blue data value corresponding to the blue data. Each of the red data value, the green data value, and the blue data value may indicate a luminance value within a predetermined range (e.g., 0 to 255).

The processor 91 may determine a maximum value of the luminance values of pixels included in an image block as a luminance value of a dimming block corresponding to the image block. For example, the processor 91 may determine a maximum value of luminance values of pixels included in the i-th image block IB(i) as a luminance value L(i) of an i-th dimming block, and may determine a maximum value of luminance values of pixels included in a j-th image block IB(j) as a luminance value L(j) of a j-th dimming block.

The processor 91 may generate the dimming data by combining the luminance values of the plurality of dimming blocks 200.

As such, the image processor 90 may decode the video signal obtained by the content receiver 80 into image data, and may generate the dimming data from the image data. In addition, the image processor 90 may transmit the image data and the dimming data to the liquid crystal panel 20 and the light source apparatus 100, respectively.

The liquid crystal panel 20 includes a plurality of pixels P capable of transmitting or blocking light, and the plurality of pixels P are arranged in a matrix form. In other words, the plurality of pixels P may be arranged in a plurality of rows and a plurality of columns.

As described above, each of the plurality of pixels P may include a red sub-pixel PR, a green sub-pixel PG, a blue sub-pixel PB, and a transparent sub-pixel PT.

The panel driver 30 may receive the image data from the image processor 90 and drive the liquid crystal panel 20 according to the image data. In other words, the panel driver 30 may convert image data, which is a digital signal (hereinafter, referred to as ‘digital image data’), into an analog image signal, which is an analog voltage signal, and may provide the converted analog image signal to the liquid crystal panel 20. Optical properties (e.g., light transmittance) of the plurality of pixels included in the liquid crystal panel 20 may change according to the analog image signal.

Operating the liquid crystal panel 20 according to the image data may include controlling an opening degree of each of the red sub-pixel PR, the green sub-pixel PG, the blue sub-pixel PB, and the transparent sub-pixel PT according to the image data.

Controlling the opening degree of each of the red sub-pixel PR, the green sub-pixel PG, the blue sub-pixel PB, and the transparent sub-pixel PT may include controlling an opening degree of each of the first liquid crystal cell 25R, the second liquid crystal cell 25G, the third liquid crystal cell 25B, and the fourth liquid crystal cell 25T.

The panel driver 30 may include, for example, a timing controller, a data driver, a scan driver, and the like.

The timing controller may receive image data from the image processor 90 and output the image data and a drive control signal to the data driver and the scan driver. The drive control signal may include a scan control signal and a data control signal, and the scan control signal and the data control signal may be used to control operations of the scan driver and the data driver, respectively.

The scan driver may receive a scan control signal from the timing controller, and may input-activate any one of the plurality of rows in the liquid crystal panel 20 according to the scan control signal. In other words, the scan driver may convert pixels, included in a single row among the plurality of pixels arranged in the plurality of rows and the plurality of columns, into a state capable of receiving an analog image signal. In this instance, the other pixels input-deactivated, except for the pixels input-activated by the scan driver, may not receive an analog image signal.

The data driver may receive image data and a data control signal from the timing controller and output the image data to the liquid crystal panel 20 according to the data control signal. For example, the data driver may receive the digital image data from the timing controller and convert the digital image data into an analog image signal. In addition, the data driver may provide the analog image signal to pixels included in any one row input-activated by the scan driver. In this instance, the pixels input-activated by the scan driver receive the analog image signal, and optical properties (e.g., light transmittance) of the input-activated pixels may change according to the received analog image signal.

As described above, the panel driver 30 may operate (drive) the liquid crystal panel 20 according to image data. As a result, an image corresponding to the image data may be displayed on the liquid crystal panel 20.

The light source apparatus 100 includes a plurality of light sources 111 that emit light, and the plurality of light sources 111 are arranged in a matrix form. In other words, the plurality of light sources 111 may be arranged in a plurality of rows and a plurality of columns. In addition, the light source apparatus 100 may be divided into a plurality of dimming blocks 200, and each of the plurality of dimming blocks 200 may include at least one light source.

The dimming driver 170 may receive dimming data from the image processor 90 and drive the light source apparatus 100 according to the dimming data. Here, the dimming data may include information about a luminance of each of the plurality of dimming blocks 200 or information about a brightness of the light sources included in each of the plurality of dimming blocks 200.

The dimming driver 170 may convert the dimming data, which is a digital signal, into an analog dimming signal, which is an analog voltage signal, and may provide the analog dimming signal to the light source apparatus 100. According to the analog dimming signal, an intensity of light emitted by the light sources included in each of the plurality of dimming blocks 200 may change.

In particular, the dimming driver 170 may provide the analog dimming signal sequentially to the plurality of dimming blocks 200 by an active matrix method, instead of directly providing the analog dimming signal to all of the plurality of dimming blocks 200.

As described above, the plurality of dimming blocks 200 may be arranged in a matrix form in the light source apparatus 100. In other words, the plurality of dimming blocks 200 may be arranged in a plurality of rows and a plurality of columns in the light source apparatus 100.

The dimming driver 170 may provide the analog dimming signal sequentially to dimming blocks belonging to each of the plurality of rows or to dimming blocks belonging to each of the plurality of columns.

For example, the dimming driver 170 may input-activate dimming blocks belonging to any one row of the plurality of dimming blocks 200, and may provide the analog dimming signal to the input-activated dimming blocks. Thereafter, the dimming driver 170 may input-activate dimming blocks belonging to another row of the plurality of dimming blocks 200, and may provide the analog dimming signal to the input-activated dimming blocks.

The dimming driver 170 may receive dimming data from the image processor 90, and may drive the driving device 300 according to the dimming data.

The driving device 300 may be configured to control at least one of the plurality of dimming blocks 200. The driving device 300 may control the dimming block 200 based on a control signal received from the dimming driver 170.

The driving device 300 may be referred to as a driving integrated circuit (IC) or a pixel IC, and the like, in that the driving device 300 is an integrated circuit for driving at least one of the plurality of dimming blocks 200.

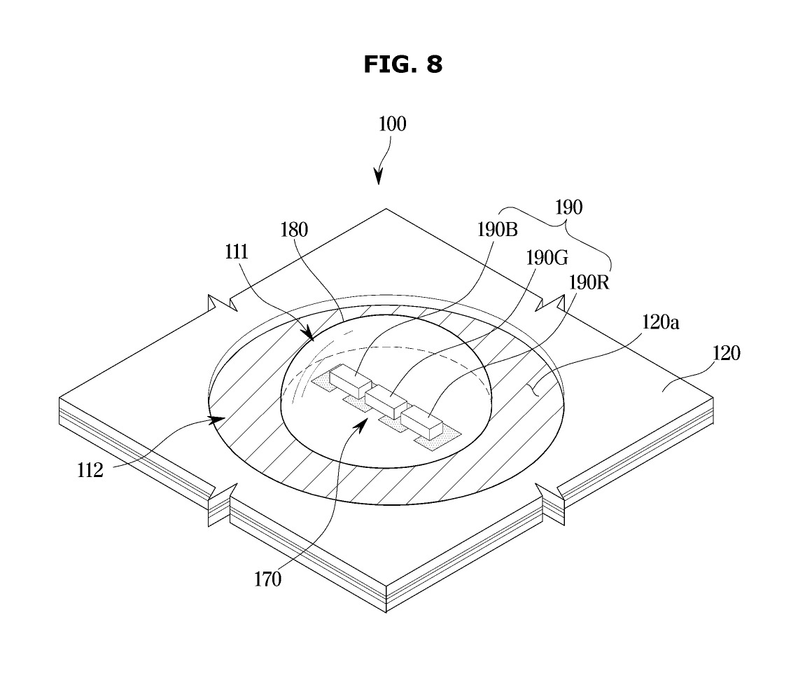

FIG. 8 illustrates an example of a light-emitting device included in a backlight unit according to one or more embodiments.

Referring to FIG. 8, the light-emitting device 111 may include the red LED 190R, the green LED 190G, and the blue LED 190B.

The LED (190R, 190G, and 190B; 190) may be a mini LED having a size of 500μm × 500μm or less.

The red LED 190R may include at least one red LED connected in series to each other. The green LED 190G may include at least one green LED connected in series to each other. The blue LED 190B may include at least one blue LED connected in series to each other.

A plurality of LED groups 170 may be arranged in a two-dimensional matrix form on the upper surface of the substrate 112. That is, as shown in FIG. 4, as the plurality of light-emitting devices 111 are arranged in rows and columns, the plurality of LED groups 170 may be arranged in a two-dimensional matrix form.

In addition, according to embodiments, the plurality of light sources may be arranged such that three adjacent light sources form a substantially equilateral triangle. In this instance, a single light source may be disposed adjacent to six light sources. In addition, a distance between the single light source and each of the six adjacent light sources may be substantially the same.

However, the arrangement of the plurality of light-emitting devices 111 is not limited to the arrangement described above, and the plurality of light-emitting devices 111 may be disposed in various patterns to allow light to be emitted with uniform luminance.

The light-emitting device 111 may employ a device capable of emitting white light (light having a plurality of peak wavelengths, for example, mixed light of red light, green light, and blue light) in various directions when power is supplied.

That is, a single light-emitting device 111 may emit white light by including the red LED 190R, the green LED 190G, and the blue LED 190B.

An intensity of the red light emitted by the red LED 190R, an intensity of the green light emitted by the green LED 190G, and an intensity of the blue light emitted by the blue LED 190B may be independently changed based on the dimming data.

As shown in FIG. 8, each of the plurality of light-emitting devices 111 may include the LED group 170 and an optical dome 180.

A thickness of the backlight unit 100 may also be reduced to reduce a thickness of the display apparatus 10. Each of the plurality of light-emitting devices 111 is thinned, and its structure is simplified in order to reduce the thickness of the backlight unit 100.

Each LED included in the LED group 170 may include a P-type semiconductor and an N-type semiconductor for emitting light by recombination of holes and electrons. In addition, the LED 190 may be provided with a pair of electrodes for supplying holes and electrons to the P-type semiconductor and the N-type semiconductor, respectively.

Each LED (190R, 190G, and 190B; 190) may be configured to convert electrical energy into light energy. Each LED (190R, 190G, and 190B; 190) may emit light having a maximum intensity at a predetermined wavelength based on the supplied power. For example, the blue LED 190B may emit blue light having a peak value at a wavelength representing blue (e.g., a wavelength between 430 nm and 495 nm).

For example, a multilayer reflective structure in which a plurality of insulating films having different refractive indices are alternately stacked may be provided on the upper surface and/or the lower surface of each LED (190R, 190G, and 190B; 190). For example, the multilayer reflective structure may be configured as a distributed Bragg reflector (DBR). The DBR is a structure in which two or more materials having different refractive indices are alternately stacked, and may refer to an optical element that provides high reflectance for light of a specific wavelength according to the principle of forming an optical path difference for each wavelength and inducing strong reflection in a specific frequency band.

In addition, each LED (190R, 190G, and 190B; 190) of the LED group 170 may be directly attached to the substrate 112 by a chip on board (COB) method. For example, the light-emitting device 111 may include the LED 190 in which a LED chip or a LED die is directly attached to the substrate 112 without separate packaging.

The LED 190 may be manufactured as a flip-chip type. The LED 190 of the flip chip type may be formed by welding, upon attaching an LED being a semiconductor device to the substrate 112, an electrode pattern of a semiconductor device as it is to the substrate 112 without using a middle medium, such as a metal lead (wire) or a ball grid array (BGA). As such, by using neither a metal lead (wire) nor a ball grid array, the light-emitting device 111 including the LED 190 of the flip chip type may be miniaturized.

Although the flip-chip type LED 190 directly welded to the substrate 112 by the chip on board method has been described above, the light-emitting device 111 is not limited to the flip-chip type LED. For example, the light-emitting device 111 may include a package-type LED.

The optical dome 180 may cover the LED group 170. That is, the optical dome 180 may cover the red LED 190R, the green LED 190G, and the blue LED 190B included in the LED group 170.

The optical dome 180 may refract and mix the red light, the green light, and the blue light emitted from the red LED 190R, the green LED 190G, and the blue LED 190B, respectively, thereby emitting white light.

As such, the optical dome 180 may emit white light by mixing red light, green light, and blue light, and reduce a distance required for mixing to white light, compared to a case in which no optical dome 180 exists, thereby reducing an optical distance (OD) required for changing point light sources to a surface light source.

In addition, the optical dome 180 may prevent or suppress the LED 190 from being damaged by a mechanical action from outside and/or by a chemical action.

The optical dome 180 may be in a shape of a dome resulting from cutting, for example, a sphere with a plane not including a center of the sphere, or in a shape of a hemisphere resulting from cutting a sphere with a plane including a center of the sphere. A vertical section of the optical dome 180 may be in a shape of, for example, a segment of a circle or a semicircle.

The optical dome 180 may be formed of silicon or epoxy resin. For example, the optical dome 180 may be formed by discharging molten silicon or a molten epoxy resin onto the LED 190 through a nozzle, etc., and then hardening the silicon or epoxy resin.

The optical dome 180 may be optically transparent or translucent. Light emitted from the LED 190 may pass through the optical dome 180 and be emitted to the outside.

In this instance, the dome-shaped optical dome 180 may refract light, like a lens. For example, light emitted from the LED 190 may be refracted by the optical dome 180 and dispersed.

As such, the optical dome 180 may not only protect the LED 190 from external mechanical action and/or chemical action or electrical action, but also disperse light emitted from the LED 190.

Although the optical dome 180 in the form of a silicon dome has been described above, the light-emitting device 111 is not limited to including the optical dome 180. For example, the light-emitting device 111 may include a lens for dispersing light emitted from the LED.

As described above, according to the present disclosure, because each light-emitting device 111 includes the red LED 190R, the green LED 190G, and the blue LED 190B, higher color purity, a higher contrast ratio, and higher image quality may be achieved in a local dimming operation than in local dimming using single light.

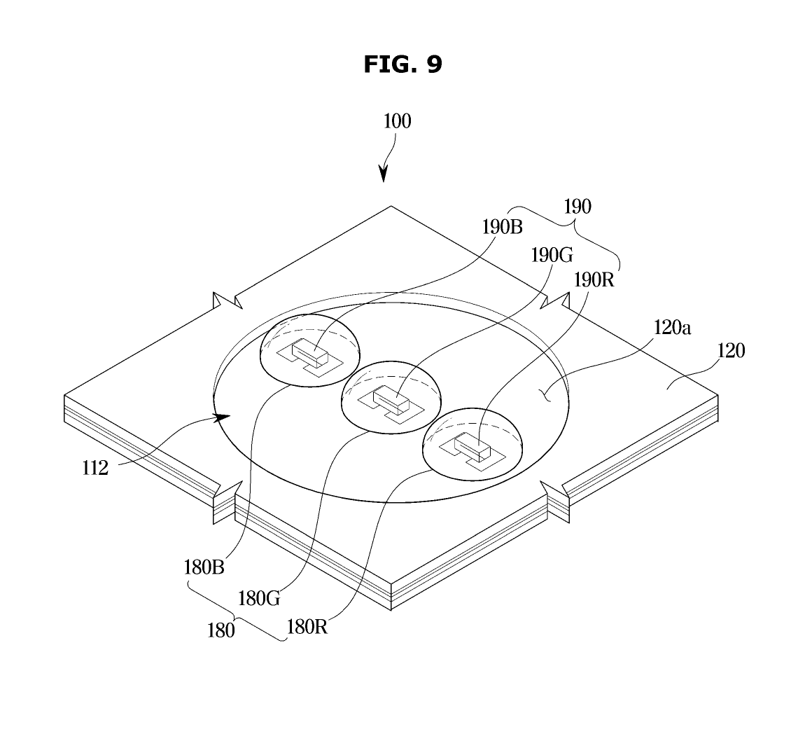

FIG. 9 illustrates another example of a light-emitting device included in a backlight unit according to one or more embodiments.

Referring to FIG. 9, in one or more embodiments, the optical dome 180 may include a first optical dome 180R covering the red LED 190R included in the LED group 170, a second optical dome 180G covering the green LED 190G included in the LED group 170, and a third optical dome 180B covering the blue LED 190B included in the LED group 170.

As the light source apparatus 100 includes the optical domes 180R, 180G, and 180B covering the red LED 190R, the green LED 190G, and the blue LED 190B, respectively, light emission stability of the LED group 170 may be improved.

The plurality of dimming blocks 200 including the plurality of light-emitting devices 111 may each correspond to the plurality of pixels P.

The light-emitting device 111 including the red LED 190R, the green LED 190G, and the blue LED 190B may correspond to the plurality of pixels P.

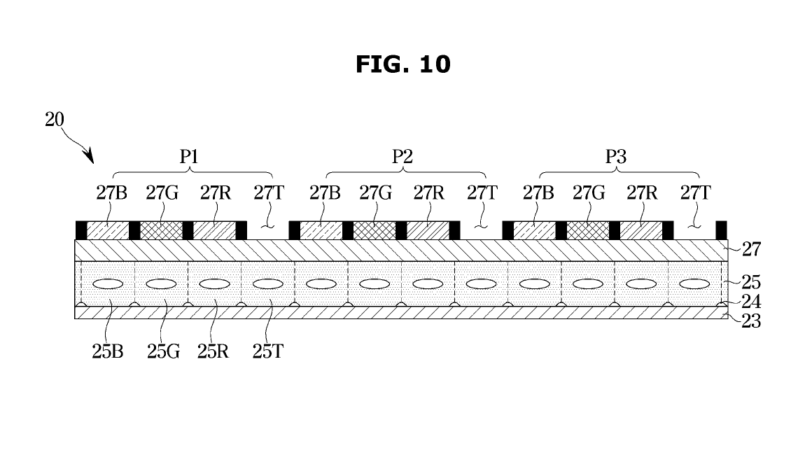

FIG. 10 illustrates an example of a configuration of a liquid crystal panel according to one or more embodiments.

Referring to FIG. 10, the liquid crystal panel 20 according to one or more embodiments may include a first sub-pixel PR formed by aligning the first liquid crystal cell 25R and the red filter 27R, a second sub-pixel PG formed by aligning the second liquid crystal cell 25G and the green filter 27G, a third sub-pixel PB formed by aligning the third liquid crystal cell 25B and the blue filter 27B, and a fourth sub-pixel PT formed by aligning the fourth liquid crystal cell 25T and the transparent region 27T.

The first sub-pixel PR may be referred to as a red sub-pixel PR in that the first sub-pixel PR selectively emits red light output from the red LED 190R.

The second sub-pixel PG may be referred to as a green sub-pixel PG in that the second sub-pixel PG selectively emits green light output from the green LED 190G.

The third sub-pixel PB may be referred to as a blue sub-pixel PB in that the third sub-pixel PB selectively emits blue light output from the blue LED 190B.

The fourth sub-pixel PT may be referred to as a transparent sub-pixel PT in that the fourth sub-pixel PT selectively emits light output from the red LED 190R, the green LED 190G, and the blue LED 190B.

The first to fourth sub-pixels PR, PG, PB, and PT may form each pixel P1, P2, and P3.

An arrangement order of the first to fourth sub-pixels PR, PG, PB, and PT within each of the pixels P1, P2, and P3 may vary according to various embodiments.

For example, the first to fourth sub-pixels PR, PG, PB, and PT within each of the pixels P1, P2, and P3 may be arranged in an order of the first, second, third, and fourth sub-pixels PR, PG, PB, and PT, an order of the first, second, fourth, and third sub-pixels PR, PG, PT, and PB, an order of the first, third, second, and fourth sub-pixels PR, PB, PG, and PT, an order of the first, third, fourth, and second sub-pixels PR, PB, PT, and PG, an order of the first, fourth, second, and third sub-pixels PR, PT, PG, and PB, an order of the first, fourth, third, and second sub-pixels PR, PT, PB, and PG, an order of the second, first, third, and fourth sub-pixels PG, PR, PB, and PT, an order of the second, first, fourth, and third sub-pixels PG, PR, PT, and PB, an order of the second, third, first, and fourth sub-pixels PG, PB, PR, and PT, an order of the second, third, fourth, and first sub-pixels PG, PB, PT, and PR, an order of the second, fourth, first, and third sub-pixels PG, PT, PR, and PB, an order of the second, fourth, third, and first sub-pixels PG, PT, PB, and PR, an order of the third, first, second, and fourth sub-pixels PB, PR, PG, and PT, an order of the third, first, fourth, and second sub-pixels PB, PR, PT, and PG, an order of the third, second, first, and fourth sub-pixels PB, PG, PR, and PT, an order of the third, second, fourth, and first sub-pixels PB, PG, PT, and PR, an order of the third, fourth, first, and second sub-pixels PB, PT, PR, and PG, an order of the third, fourth, second, and first sub-pixels PB, PT, PG, and PR, an order of the fourth, first, second, and third sub-pixels PT, PR, PG, and PB, an order of the fourth, first, third, and second sub-pixels PT, PR, PB, and PG, an order of the fourth, second, first, and third sub-pixels PT, PG, PR, and PB, an order of the fourth, second, third, and first sub-pixels PT, PG, PB, and PR, an order of the fourth, third, first, and second sub-pixels PT, PB, PR, and PG, or an order of the fourth, third, second, and first sub-pixels PT, PB, PG, and PR in a horizontal direction of the liquid crystal panel 20 (e.g., a width direction or a left-right direction of the display apparatus 10) or a vertical direction of the liquid crystal panel 20 (e.g., a length direction or an up-down direction of the display apparatus 10).

In one or more embodiments, a width of each of the first to fourth sub-pixels PR, PG, PB, and PT may be equal to each other.

According to one or more embodiments of the present disclosure, by forming the width of each of the first to fourth sub-pixels PR, PG, PB, and PT to be the same, a manufacturing process of the liquid crystal panel 20 may be simplified.

In the present disclosure, the width of each of the sub-pixels PR, PG, PB, and PT may refer to a length of the sub-pixel based on the horizontal direction of the liquid crystal panel 20 or the vertical direction of the liquid crystal panel 20.

In the present disclosure, the width of each of the sub-pixels PR, PG, PB, and PT may refer to a width of each of the liquid crystal cells 25R, 25G, 25B, and 25T controllable independently of each other or a width of each of the red filter 27R, the green filter 27G, the blue filter 27B, and the transparent region 27T.

In the present disclosure, the width of each of the sub-pixels PR, PG, PB, and PT may refer to an area occupied by each of the sub-pixels PR, PG, PB, and PT.

Because the backlight unit 100 of the display apparatus 10 according to one or more embodiments includes the light-emitting device 111 including the red LED 190R, the green LED 190G, and the blue LED 190B, the color of light may be adjusted from when light outputs. However, because one light-emitting device 111 corresponds to the plurality of pixels P, the color filter layer 27 for adjusting the color of light for each pixel is required.

Meanwhile, because the red filter 27R, the green filter 27G, and the blue filter 27B are absorption filters, light loss may occur when transmitting light of a specific wavelength band.

The display apparatus 10 according to one or more embodiments may include the transparent sub-pixel PT in addition to the red sub-pixel PR, the green sub-pixel PG, and the blue sub-pixel PB, in order to compensate for light loss caused by the red filter 27R, the green filter 27G, and the blue filter 27B.

The transparent sub-pixel PT may be opened even when transmitting monochromatic light. Accordingly, in a case where the width of each of the first to fourth sub-pixels PR, PG, PB, and PT is equal, the color of light corresponding to a sub-pixel adjacent to the fourth sub-pixel PT may be concentrated and output (intensively emitted).

For example, in a case where green monochromatic light is output in the configuration of the liquid crystal panel 20 shown in FIG. 10, the green monochromatic light is output through the green sub-pixel PG and the transparent sub-pixel PT, which are separated by one sub-pixel spacing, and thus the green monochromatic light may be evenly spread.

On the other hand, in a case where red monochromatic light is output in the configuration of the liquid crystal panel 20 shown in FIG. 10, the red monochromatic light is output through the red sub-pixel PR and the transparent sub-pixel PT arranged adjacent to each other, and thus the red monochromatic light may be concentrated and output in a specific region.

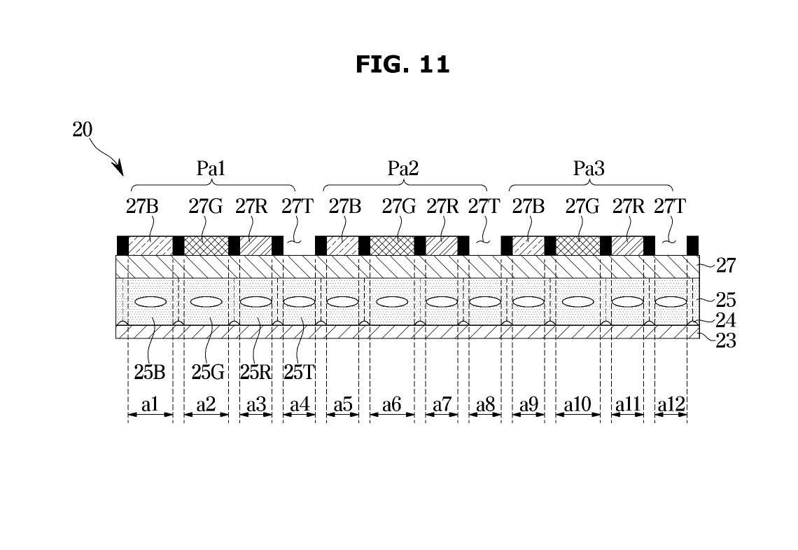

FIGS. 11, 12, and 13 illustrate other examples of a configuration of a liquid crystal panel according to one or more embodiments.

Referring to FIGS. 11, 12, and 13, in one or more embodiments, widths of at least two sub-pixels among the first to fourth sub-pixels PR, PG, PB, and PT may be different from each other.

For example, among the first to fourth sub-pixels PR, PG, PB, and PT, a width of each of the fourth sub-pixel PT and a sub-pixel adjacent to the fourth sub-pixel PT may be smaller than a width of a sub-pixel not adjacent to the fourth sub-pixel PT.

The plurality of pixels P may be arranged in a two-dimensional matrix form, and the sub-pixel adjacent to the fourth sub-pixel PT may refer to a sub-pixel adjacent to the fourth sub-pixel PT in a row direction and/or column direction.

In the present disclosure, the sub-pixel adjacent to the fourth sub-pixel PT may refer to a sub-pixel arranged right next to the fourth sub-pixel PT. For example, no sub-pixel may be arranged between the fourth sub-pixel PT and the sub-pixel adjacent to the fourth sub-pixel PT.

In the present disclosure, another sub-pixel may be arranged between the sub-pixel not adjacent to the fourth sub-pixel PT and the fourth sub-pixel PT. For example, according to the present disclosure, a sub-pixel #1 may be considered “not adjacent to” a sub-pixel #2 if a sub-pixel #3 is between the sub-pixel #1 and the sub-pixel #2.

Referring to FIG. 11, the fourth sub-pixel PT may be arranged between the first sub-pixel PR and the third sub-pixel PB, and the second sub-pixel PG may not be adjacent to the fourth sub-pixel PT.

In a case where the fourth sub-pixel PT is arranged between the first sub-pixel PR and the third sub-pixel PB, each of a width a3, a7, and a11 of the first sub-pixel PR, a width a5 and a9 of the third sub-pixel PB, and a width a4, a8, and a12 of the fourth sub-pixel PT may be smaller than a width a2, a6, and a10 of the second sub-pixel PG.

For example, in the case where the fourth sub-pixel PT is arranged between the first sub-pixel PR and the third sub-pixel PB, each of the width a3, a7, and a11 of the first sub-pixel PR, the width a5 and a9 of the third sub-pixel PB, and the width a4, a8, and a12 of the fourth sub-pixel PT may be less than or equal to half of the width a2, a6, and a10 of the second sub-pixel PG.

In one or more embodiments, a sub-pixel (e.g., the third sub-pixel PB) arranged at an edge of the liquid crystal panel 20 may not be adjacent to the fourth sub-pixel PT. A width a1 of the third sub-pixel PB arranged at the edge of the liquid crystal panel 20 and not adjacent to the fourth sub-pixel PT may be equal to the width a2, a6, and a10 of the second sub-pixel PG.

In one or more embodiments, the plurality of pixels P, each of which includes the first sub-pixel PR, the second sub-pixel PG, the third sub-pixel PB, and the fourth sub-pixel PT, may be arranged in a two-dimensional matrix form.

For example, a first pixel Pa1 may be arranged adjacent to a second pixel Pa2, and the second pixel Pa2 may be arranged adjacent to a third pixel Pa3.

The fourth sub-pixel PT being arranged between the first sub-pixel PR and the third sub-pixel PB may include the fourth sub-pixel PT being arranged between the first sub-pixel PR and the third sub-pixel PB within one pixel, the fourth sub-pixel PT of the first pixel Pa1 being arranged between the first sub-pixel PR of the first pixel Pa1 and the third sub-pixel PB of the second pixel Pa2, and/or the fourth sub-pixel PT of the first pixel Pa1 being arranged between the first sub-pixel PR of the second pixel Pa2 and the third sub-pixel PB of the first pixel Pa1.

In one or more embodiments, each of the width a3 of the first sub-pixel PR of the first pixel Pa1 and the width a5 of the third sub-pixel PB of the second pixel Pa2, adjacent to the fourth sub-pixel PT of the first pixel Pa1, may be smaller than each of the width a2 of the second sub-pixel PG of the first pixel Pa1 and the width a6 of the second sub-pixel PG of the second pixel Pa2 not adjacent to the fourth sub-pixel PT of the first pixel Pa1.

In one or more embodiments, each of the width a7 of the first sub-pixel PR of the second pixel Pa2 and the width a9 of the third sub-pixel PB of the third pixel Pa3, adjacent to the fourth sub-pixel PT of the second pixel Pa2, may be smaller than each of the width a6 of the second sub-pixel PG of the second pixel Pa2 and the width a10 of the second sub-pixel PG of the third pixel Pa3 not adjacent to the fourth sub-pixel PT of the second pixel Pa2.

In one or more embodiments, the width a11 of the first sub-pixel PR of the third pixel Pa3, adjacent to the fourth sub-pixel PT of the third pixel Pa3, may be smaller than the width a10 of the second sub-pixel PG of the third pixel Pa3.

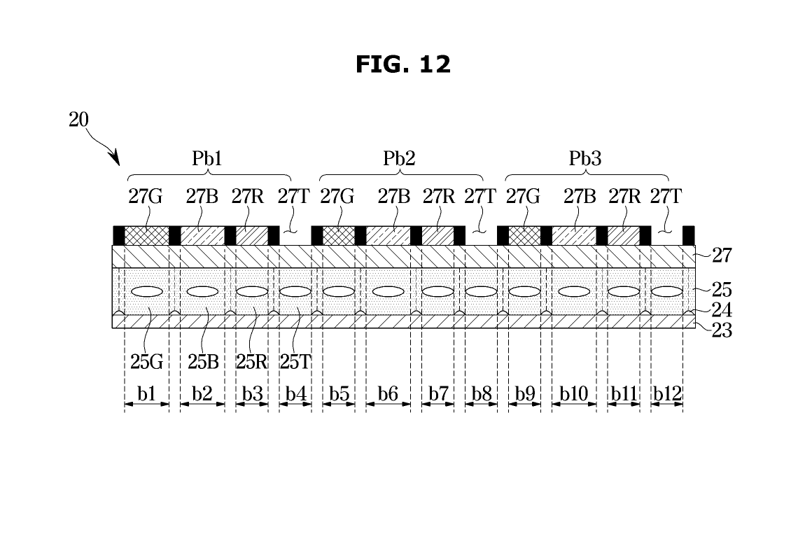

Referring to FIG. 12, the fourth sub-pixel PT may be arranged between the first sub-pixel PR and the second sub-pixel PG, and the third sub-pixel PB may not be adjacent to the fourth sub-pixel PT.

In a case where the fourth sub-pixel PT is arranged between the first sub-pixel PR and the second sub-pixel PG, each of a width b3, b7, and b11 of the first sub-pixel PR, a width b5 and b9 of the second sub-pixel PG, and a width b4, b8, and b12 of the fourth sub-pixel PT may be smaller than a width b2, b6, and b10 of the third sub-pixel PB.

For example, in a case where the fourth sub-pixel PT is arranged between the first sub-pixel PR and the second sub-pixel PG, each of the width b3, b7, and b11 of the first sub-pixel PR, the width b5 and b9 of the second sub-pixel PG, and the width b4, b8, and b12 of the fourth sub-pixel PT may be less than or equal to half of the width b2, b6, and b10 of the third sub-pixel PB.

In one or more embodiments, a sub-pixel (e.g., the second sub-pixel PG) arranged at an edge of the liquid crystal panel 20 may not be adjacent to the fourth sub-pixel PT. A width b1 of the second sub-pixel PG arranged at the edge of the liquid crystal panel 20 and not adjacent to the fourth sub-pixel PT may be equal to the width b2, b6, and b10 of the third sub-pixel PB.

In one or more embodiments, the plurality of pixels P, each of which includes the first sub-pixel PR, the second sub-pixel PG, the third sub-pixel PB, and the fourth sub-pixel PT, may be arranged in a two-dimensional matrix form.

For example, a first pixel Pb1 may be arranged adjacent to a second pixel Pb2, and the second pixel Pb2 may be arranged adjacent to a third pixel Pb3.

The fourth sub-pixel PT being arranged between the first sub-pixel PR and the second sub-pixel PG may include the fourth sub-pixel PT being arranged between the first sub-pixel PR and the second sub-pixel PG within one pixel, the fourth sub-pixel PT of the first pixel Pb1 being arranged between the first sub-pixel PR of the first pixel Pb1 and the second sub-pixel PG of the second pixel Pb2, and/or the fourth sub-pixel PT of the first pixel Pb1 being arranged between the first sub-pixel PR of the second pixel Pb2 and the second sub-pixel PG of the first pixel Pb1.

In one or more embodiments, each of the width b3 of the first sub-pixel PR of the first pixel Pb1 and the width b5 of the second sub-pixel PG of the second pixel Pb2, adjacent to the fourth sub-pixel PT of the first pixel Pb1, may be smaller than each of the width b2 of the third sub-pixel PB of the first pixel Pb1 and the width b6 of the third sub-pixel PB of the second pixel Pb2 not adjacent to the fourth sub-pixel PT of the first pixel Pb1.

In one or more embodiments, each of the width b7 of the first sub-pixel PR of the second pixel Pb2 and the width b9 of the second sub-pixel PG of the third pixel Pb3, adjacent to the fourth sub-pixel PT of the second pixel Pb2, may be smaller than each of the width b6 of the third sub-pixel PB of the second pixel Pb2 and the width b10 of the third sub-pixel PB of the third pixel Pb3 not adjacent to the fourth sub-pixel PT of the second pixel Pb2.

In one or more embodiments, the width b11 of the first sub-pixel PR of the third pixel Pb3 adjacent to the fourth sub-pixel PT of the third pixel Pb3 may be smaller than the width b10 of the third sub-pixel PB of the third pixel Pb3.

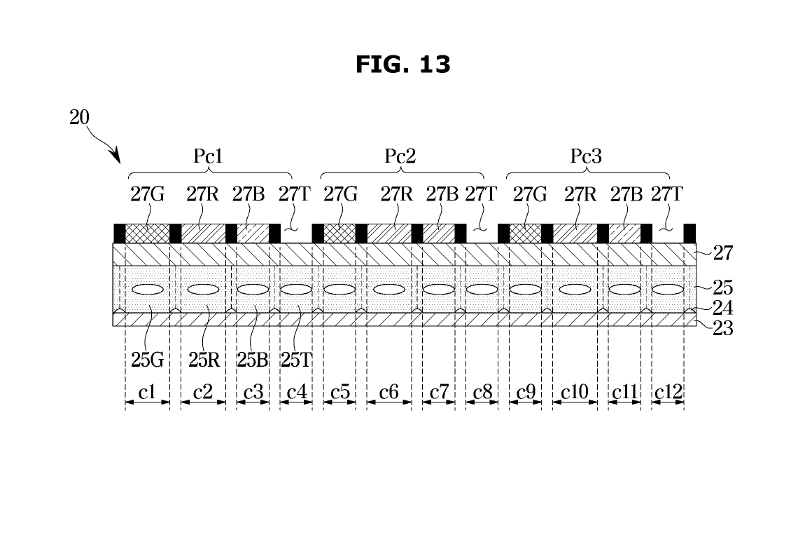

Referring to FIG. 13, the fourth sub-pixel PT may be arranged between the second sub-pixel PG and the third sub-pixel PB, and the first sub-pixel PR may not be adjacent to the fourth sub-pixel PT.

In a case where the fourth sub-pixel PT is arranged between the second sub-pixel PG and the third sub-pixel PB, each of a width c3, c7, and c11 of the third sub-pixel PB, a width c5 and c9 of the second sub-pixel PG, and a width c4, c8, and c12 of the fourth sub-pixel PT may be smaller than a width c2, c6, and c10 of the first sub-pixel PR.

For example, in the case where the fourth sub-pixel PT is arranged between the second sub-pixel PG and the third sub-pixel PB, each of the width c3, c7, and c11 of the third sub-pixel PB, the width c5 and c9 of the second sub-pixel PG, and the width c4, c8, and c12 of the fourth sub-pixel PT may be less than or equal to half of the width c2, c6, and c10 of the first sub-pixel PR.

In one or more embodiments, a sub-pixel (e.g., the second sub-pixel PG) arranged at an edge of the liquid crystal panel 20 may not be adjacent to the fourth sub-pixel PT. A width c1 of the second sub-pixel PG arranged at the edge of the liquid crystal panel 20 and not adjacent to the fourth sub-pixel PT may be equal to the width c2, c6, and c10 of the first sub-pixel PR.

In one or more embodiments, the plurality of pixels P, each of which includes the first sub-pixel PR, the second sub-pixel PG, the third sub-pixel PB, and the fourth sub-pixel PT, may be arranged in a two-dimensional matrix form.

For example, a first pixel Pc1 may be arranged adjacent to a second pixel Pc2, and the second pixel Pc2 may be arranged adjacent to a third pixel Pc3.

The fourth sub-pixel PT being arranged between the second sub-pixel PG and the third sub-pixel PB may include the fourth sub-pixel PT being arranged between the second sub-pixel PG and the third sub-pixel PB within one pixel, the fourth sub-pixel PT of the first pixel Pc1 being arranged between the second sub-pixel PG of the first pixel Pc1 and the third sub-pixel PB of the second pixel Pc2, and/or the fourth sub-pixel PT of the first pixel Pc1 being arranged between the second sub-pixel PG of the second pixel Pc2 and the third sub-pixel PB of the first pixel Pc1.

In one or more embodiments, each of the width c3 of the third sub-pixel PB of the first pixel Pc1 and the width c5 of the second sub-pixel PG of the second pixel Pc2, adjacent to the fourth sub-pixel PT of the first pixel Pc1, may be smaller than each of the width c2 of the first sub-pixel PR of the first pixel Pc1 and the width c6 of the first sub-pixel PR of the second pixel Pc2 not adjacent to the fourth sub-pixel PT of the first pixel Pc1.

In one or more embodiments, each of the width c7 of the third sub-pixel PB of the second pixel Pc2 and the width c9 of the second sub-pixel PG of the third pixel Pc3, adjacent to the fourth sub-pixel PT of the second pixel Pc2, may be smaller than each of the width c6 of the first sub-pixel PR of the second pixel Pc2 and the width c10 of the first sub-pixel PR of the third pixel Pc3 not adjacent to the fourth sub-pixel PT of the second pixel Pc2.

In one or more embodiments, the width c11 of the third sub-pixel PB of the third pixel Pc3, adjacent to the fourth sub-pixel PT of the third pixel Pc3, may be smaller than the width c10 of the first sub-pixel PR of the third pixel Pc3.

According to one or more embodiments of the present disclosure, because the widths of the sub-pixels adjacent to the fourth sub-pixel PT are smaller than the width of the sub-pixel not adjacent to the fourth sub-pixel PT, output uniformity of monochromatic light may be improved.

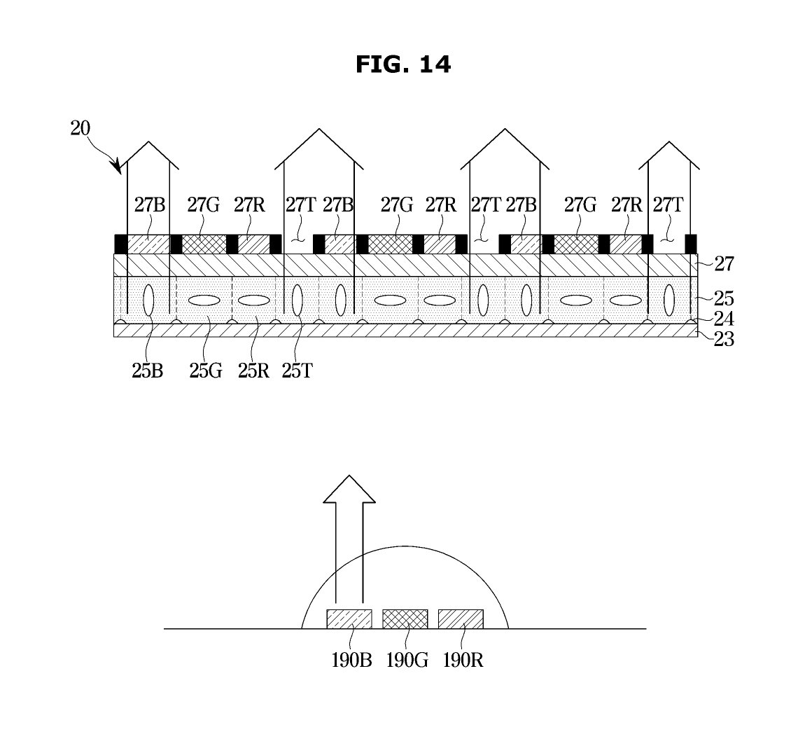

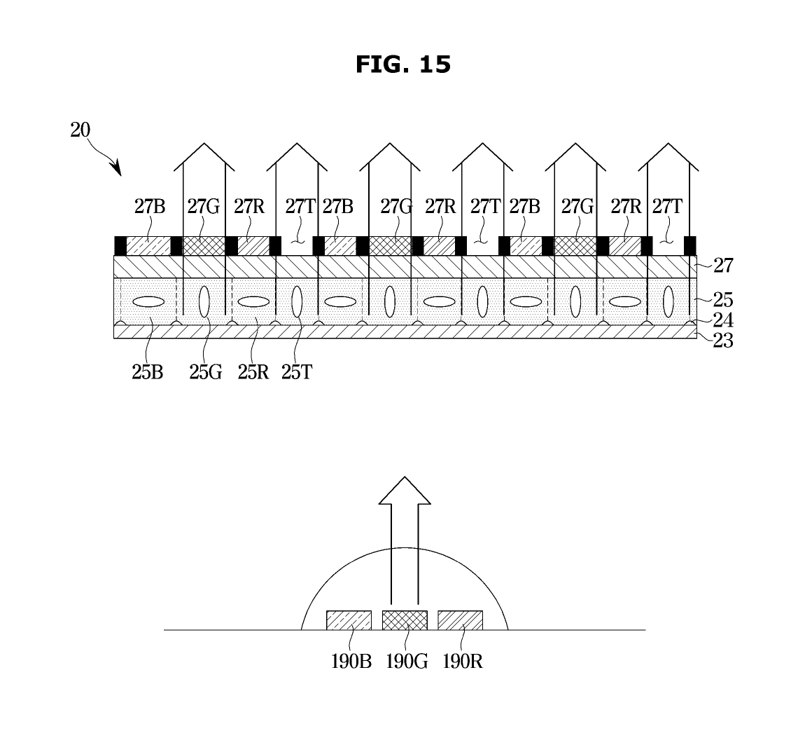

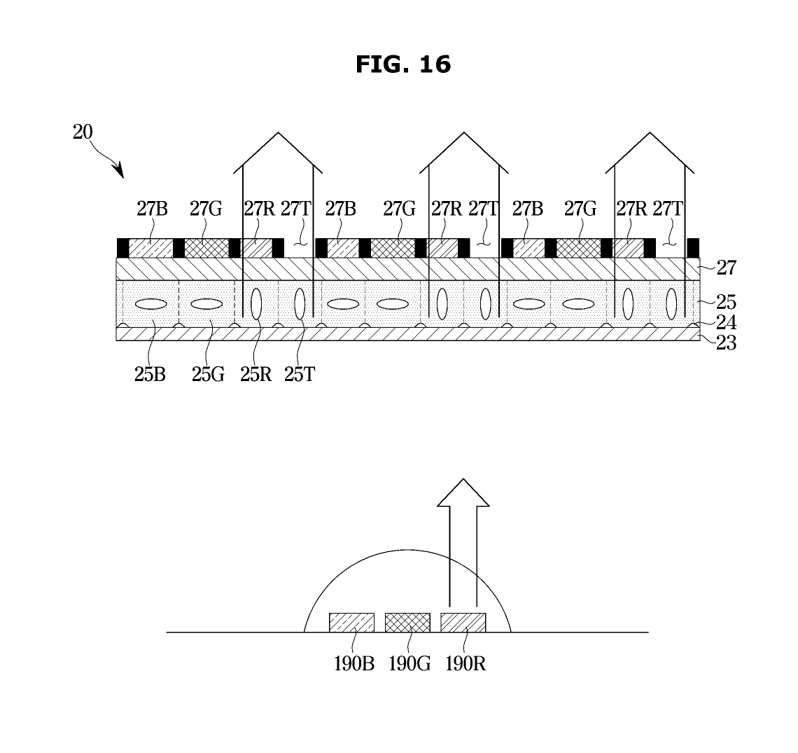

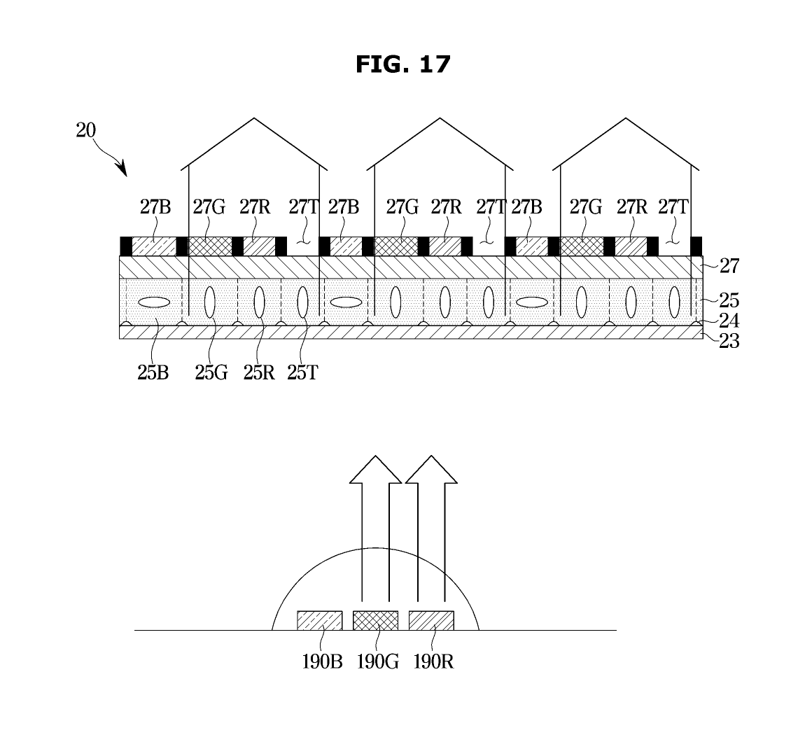

FIG. 14 is a diagram illustrating operation of the liquid crystal panel when the light-emitting device outputs blue monochromatic light according to one or more embodiments. FIG. 15 is a diagram illustrating operation of the liquid crystal panel when the light-emitting device outputs green monochromatic light according to one or more embodiments. FIG. 16 is a diagram illustrating operation of the liquid crystal panel when the light-emitting device outputs red monochromatic light according to one or more embodiments. FIG. 17 is a diagram illustrating operation of the liquid crystal panel when the light-emitting device outputs mixed light according to one or more embodiments.

In one or more embodiments, the display apparatus 10 may include a controller for controlling the light-emitting device 111 of the backlight unit 100 and the pixels P of the liquid crystal panel 20.

The controller may include the image processor 90, the panel driver 30, the dimming driver 170, and/or the driving device 300.

Controlling the light-emitting device 111 of the backlight unit 100 may include controlling a driving current flowing through the LED 190 (e.g., the red LED 190R, the green LED 190G, and the blue LED 190B) included in the light-emitting device 111 based on input data (or image data).

Controlling the pixel P of the liquid crystal panel 20 may include controlling an opening degree of each of the sub-pixels PR, PG, PB, and PT included in the pixel P.

Controlling the opening degree of each of the sub-pixels PR, PG, PB, and PT may refer to controlling the opening degree of the liquid crystal cells 25R, 25G, 25B, and 25T corresponding respectively to the sub-pixels PR, PG, PB, and PT.

Controlling the opening degree of each of the liquid crystal cells 25R, 25G, 25B, and 25T may include controlling light transmittance of each of the liquid crystal cells 25R, 25G, 25B, and 25T, controlling a driving level of each of the liquid crystal cells 25R, 25G, 25B, and 25T, and/or controlling a rotation angle of liquid crystal molecules 25a included in the liquid crystal cells 25R, 25G, 25B, and 25T.

The controller may determine a luminance value L of each of the plurality of dimming blocks 200 based on the input data.

The controller may determine a luminance value of each of the plurality of pixels P based on the input data.

The input data may include an RGB color value, and the RGB color value may include an R value corresponding to a luminance value of red light, a G value corresponding to a luminance value of green light, and a B value corresponding to a luminance value of blue light.

The R value, the G value, and the B value may be defined as a red data value, a green data value, and a blue data value, respectively.

Each of the R value, the G value, and the B value may have a data value (or luminance value) within a predetermined range (e.g., 0 to 255) corresponding to luminance. Depending on an input data processing method, a range of each of the R value, the G value, and the B value included in the input data may vary (e.g., 0 to 1000).

A specific light-emitting device (hereinafter, ‘first light-emitting device 111’) included in the plurality of dimming blocks 200 may correspond to a specific pixel (hereinafter, ‘first pixel P’) included in the plurality of pixels P.

The first light-emitting device 111 corresponding to the first pixel P may indicate that light output from the first light-emitting device 111 is projected onto the first pixel P.

A plurality of first pixels P corresponding to the first light-emitting device 111 may be provided.

The controller may control a driving current flowing through the LED 190 (e.g., the red LED 190R, the green LED 190G, and the blue LED 190B) included in the first light-emitting device 111 based on the input data.

The controller may control an opening degree of each of the sub-pixels PR, PG, PB, and PT included in the first pixel P based on the input data.

Referring to FIG. 14, in a case where the input data corresponding to the first light-emitting device 111 includes only the B value, the controller may control the first light-emitting device 111 to output blue monochromatic light.

Controlling the first light-emitting device 111 to output blue monochromatic light may include applying a driving current only to the blue LED 190B among the red LED 190R, the green LED 190G, and the blue LED 190B included in the first light-emitting device 111.

The input data including only the B value may indicate that the B value among the RGB color values has a predetermined value that is not 0, and the R value and the G value are 0.

In the case where the controller controls the first light-emitting device 111 to output blue monochromatic light, the controller may open only the third sub-pixel PB and the fourth sub-pixel PT among the first sub-pixel PR, the second sub-pixel PG, the third sub-pixel PB, and the fourth sub-pixel PT of the first pixel P.

Opening only the third sub-pixel PB and the fourth sub-pixel PT among the first sub-pixel PR, the second sub-pixel PG, the third sub-pixel PB, and the fourth sub-pixel PT may refer to opening only the third liquid crystal cell 25B and the fourth liquid crystal cell 25T among the first to fourth liquid crystal cells 25R, 25G, 25B, and 25T corresponding to the first to fourth sub-pixels PR, PG, PB, and PT.

Referring to FIG. 15, in a case where the input data corresponding to the first light-emitting device 111 includes only the G value, the controller may control the first light-emitting device 111 to output green monochromatic light.

Controlling the first light-emitting device 111 to output green monochromatic light may include applying a driving current only to the green LED 190G among the red LED 190R, the green LED 190G, and the blue LED 190B included in the first light-emitting device 111.

The input data including only the G value may indicate that the G value among the RGB color values has a predetermined value that is not 0, and the R value and the B value are 0.

In the case where the controller controls the first light-emitting device 111 to output green monochromatic light, the controller may open only the second sub-pixel PG and the fourth sub-pixel PT among the first sub-pixel PR, the second sub-pixel PG, the third sub-pixel PB, and the fourth sub-pixel PT of the first pixel P.

Opening only the second sub-pixel PG and the fourth sub-pixel PT among the first sub-pixel PR, the second sub-pixel PG, the third sub-pixel PB, and the fourth sub-pixel PT may refer to opening only the second liquid crystal cell 25G and the fourth liquid crystal cell 25T among the first to fourth liquid crystal cells 25R, 25G, 25B, and 25T corresponding to the first to fourth sub-pixels PR, PG, PB, and PT.

Referring to FIG. 16, in a case where the input data corresponding to the first light-emitting device 111 includes only the R value, the controller may control the first light-emitting device 111 to output red monochromatic light.

Controlling the first light-emitting device 111 to output red monochromatic light may include applying a driving current only to the red LED 190R among the red LED 190R, the green LED 190G, and the blue LED 190B included in the first light-emitting device 111.

The input data including only the R value may indicate that the R value among the RGB color values has a predetermined value that is not 0, and the G value and the B value are 0.

In the case where the controller controls the first light-emitting device 111 to output red monochromatic light, the controller may open only the first sub-pixel PR and the fourth sub-pixel PT among the first sub-pixel PR, the second sub-pixel PG, the third sub-pixel PB, and the fourth sub-pixel PT of the first pixel P.

Opening only the first sub-pixel PR and the fourth sub-pixel PT among the first sub-pixel PR, the second sub-pixel PG, the third sub-pixel PB, and the fourth sub-pixel PT may refer to opening only the first liquid crystal cell 25R and the fourth liquid crystal cell 25T among the first to fourth liquid crystal cells 25R, 25G, 25B, and 25T corresponding to the first to fourth sub-pixels PR, PG, PB, and PT.

Referring to FIGS. 14-16, in a case where the first light-emitting device 111 outputs monochromatic light, it may be confirmed that the monochromatic light is not concentrated and output in a portion of the pixels, but is output uniformly.

According to one or more embodiments of the present disclosure, the fourth sub-pixel PT, which does not include a color filter, may be arranged in the pixel, thereby compensating for a reduction in light efficiency caused by absorption of monochromatic light by the color filter.

According to one or more embodiments of the present disclosure, by setting the widths of the fourth sub-pixel PT and the sub-pixel adjacent to the fourth sub-pixel PT to be smaller than the width of the sub-pixel not adjacent to the fourth sub-pixel PT, output uniformity of light may be improved.

In one or more embodiments, in a case where the first light-emitting device 111 outputs monochromatic light, the controller may completely open the fourth sub-pixel PT.

According to one or more embodiments of the present disclosure, light efficiency may be increased by outputting monochromatic light that has not passed through the color filter through the fourth sub-pixel PT.

Referring to FIG. 17, in a case where the input data corresponding to the first light-emitting device 111 includes at least two of the R value, the G value, and the B value, the controller may control the first light-emitting device 111 to output mixed light in which at least two of red light, green light, and blue light are mixed.

Controlling the first light-emitting device 111 to output mixed light may include applying a driving current to at least two LEDs 190 among the red LED 190R, the green LED 190G, and the blue LED 190B included in the first light-emitting device 111.

For example, in a case where the input data corresponding to the first light-emitting device 111 includes only the R value and the G value among the R value, the G value, and the B value, the controller may apply a driving current only to the red LED 190R and the green LED 190G among the red LED 190R, the green LED 190G, and the blue LED 190B included in the first light-emitting device 111. In a case where the input data corresponding to the first light-emitting device 111 includes only the G value and the B value among the R value, the G value, and the B value, the controller may apply a driving current only to the green LED 190G and the blue LED 190B among the red LED 190R, the green LED 190G, and the blue LED 190B included in the first light-emitting device 111. In a case where the input data corresponding to the first light-emitting device 111 includes only the R value and the B value among the R value, the G value, and the B value, the controller may apply a driving current only to the red LED 190R and the blue LED 190B among the red LED 190R, the green LED 190G, and the blue LED 190B included in the first light-emitting device 111. In a case where the input data corresponding to the first light-emitting device 111 includes all of the R value, the G value, and the B value, the controller may apply a driving current to the red LED 190R, the green LED 190G, and the blue LED 190B included in the first light-emitting device 111.

In the case where the controller controls the first light-emitting device 111 to output mixed light, the controller may open sub-pixels corresponding to a color of the mixed light and the fourth sub-pixel PT among the first sub-pixel PR, the second sub-pixel PG, the third sub-pixel PB, and the fourth sub-pixel PT of the first pixel P.

For example, in the case where the controller controls the first light-emitting device 111 to output mixed light in which at least two of red light, green light, and blue light are mixed, the controller may open at least two liquid crystal cells corresponding to a color of the mixed light and the fourth liquid crystal cell 25T among the first to fourth liquid crystal cells 25R, 25G, 25B, and 25T.

In one or more embodiments, the controller may determine an opening degree of the first liquid crystal cell 25R, an opening degree of the second liquid crystal cell 25G, and an opening degree of the third liquid crystal cell 25B, respectively, based on each of the R value, the G value, and the B value corresponding to the first pixel.

Meanwhile, unlike in the case of outputting monochromatic light, when outputting mixed light, the opening degree of the fourth sub-pixel PT requires to be appropriately adjusted to ensure color differentiation between adjacent pixels. For example, in a case where the opening degrees of the fourth sub-pixels PT of each of the adjacent pixels are all set too large, colors output from the adjacent pixels are not well distinguished, and in a case where the opening degrees of the fourth sub-pixels PT of each of the adjacent pixels are all set small, more power may be consumed in the first light-emitting device 111.

As such, appropriate control of the opening degree of the fourth sub-pixel PT is required to improve inter-pixel contrast (or image sharpness) and light efficiency.

In one or more embodiments, the controller may determine the opening degree of the fourth sub-pixel PT considering all of the R value, the G value, and the B value corresponding to the first pixel P.

For example, the controller may determine a target value greater than an average value of the R value, the G value, and the B value and less than a maximum value among the R value, the G value, and the B value, and may determine the opening degree of the fourth sub-pixel PT based on the target value.

For example, the controller may open the fourth sub-pixel PT by a target opening degree greater than an average of opening degrees of the first to third sub-pixels and less than a maximum opening degree of the first to third sub-pixels.

According to one or more embodiments of the present disclosure, the display apparatus 10 that may ensure both light efficiency and image sharpness is provided.

According to one or more embodiments of the present disclosure, a display apparatus 10 may include: a backlight unit 100 including a red LED 190R, a green LED 190G, and a blue LED 190B; and a liquid crystal panel 20 through which light emitted from the backlight unit 100 passes, wherein the liquid crystal panel 20 may include: a liquid crystal layer 25 including a plurality of liquid crystal cells 25R, 25G, 25B, and 25T which are independently controllable; and color filter layers 27 and 28 arranged on the liquid crystal layer 25 and including a red filter 27R, a green filter 27G, a blue filter 27B, and a transparent region 27T, and a first liquid crystal cell 25R of the plurality of liquid crystal cells 25R, 25G, 25B, and 25T and the red filter 27R are aligned to form a first sub-pixel PR, a second liquid crystal cell 25G of the plurality of liquid crystal cells 25R, 25G, 25B, and 25T and the green filter 27G are aligned to form a second sub-pixel PG, a third liquid crystal cell 25B of the plurality of liquid crystal cells 25R, 25G, 25B, and 25T and the blue filter 27B are aligned to form a third sub-pixel PB, and a fourth liquid crystal cell 25T of the plurality of liquid crystal cells 25R, 25G, 25B, and 25T and the transparent region 27T are aligned to form a fourth sub-pixel PT.

According to one or more embodiments of the present disclosure, light efficiency may be increased by aligning the liquid crystal cell 25T and the transparent region 27T to form the fourth sub-pixel PT.

According to one or more embodiments of the present disclosure, a width of each of the fourth sub-pixel PT and a sub-pixel adjacent to the fourth sub-pixel PT may be smaller than a width of a sub-pixel not adjacent to the fourth sub-pixel PT.

According to one or more embodiments of the present disclosure, light uniformity may be improved by preventing intensive output of light of a specific color through the fourth sub-pixel PT and the sub-pixel adjacent to the fourth sub-pixel PT.

According to one or more embodiments of the present disclosure, the fourth sub-pixel PT may be positioned between the second sub-pixel PG and the third sub-pixel PB, and a width of each of the second sub-pixel PG, the third sub-pixel PB, and the fourth sub-pixel PT may be smaller than a width of the first sub-pixel PR.

According to one or more embodiments of the present disclosure, light uniformity may be improved by preventing green and blue light from being output more intensively than red light.

According to one or more embodiments of the present disclosure, the fourth sub-pixel PT may be positioned between the first sub-pixel PR and the third sub-pixel PB, and a width of each of the first sub-pixel PR, the third sub-pixel PB, and the fourth sub-pixel PT may be smaller than the width of the second sub-pixel PG.

According to one or more embodiments of the present disclosure, light uniformity may be improved by preventing red and blue light from being output more intensively than green light.

According to one or more embodiments of the present disclosure, the fourth sub-pixel PT may be positioned between the first sub-pixel PR and the second sub-pixel PG, and a width of each of the first sub-pixel PR, the second sub-pixel PG, and the fourth sub-pixel PT may be smaller than the width of the third sub-pixel PB.

According to one or more embodiments of the present disclosure, light uniformity may be improved by preventing red and green light from being output more intensively than blue light.

According to one or more embodiments of the present disclosure, the liquid crystal panel 20 may include a plurality of pixels P including the first sub-pixel PR, the second sub-pixel PG, the third sub-pixel PB, and the fourth sub-pixel PT.

According to one or more embodiments of the present disclosure, the plurality of pixels P may include a first pixel and a second pixel adjacent to each other, and a width of each of the fourth sub-pixel PT of the first pixel, the fourth sub-pixel PT of the second pixel, a sub-pixel adjacent to the fourth sub-pixel PT of the first pixel, and a sub-pixel adjacent to the fourth sub-pixel PT of the second pixel may be smaller than a width of each sub-pixel not adjacent to the fourth sub-pixel PT of the first pixel and the fourth sub-pixel PT of the second pixel.

According to one or more embodiments of the present disclosure, light uniformity may be improved by preventing intensive output of light of a specific color through the fourth sub-pixel PT of a specific pixel and sub-pixels of pixels different from the fourth sub-pixel PT of the specific pixel.

According to one or more embodiments of the present disclosure, each of the red filter 27R, the green filter 27G, and the blue filter 27B may be an absorption filter configured to transmit a specific wavelength band of incident light and absorb remaining wavelength bands.

According to one or more embodiments of the present disclosure, by disposing the fourth sub-pixel PT, the reduction in light efficiency due to light loss of the absorption filter may be compensated.

According to one or more embodiments of the present disclosure, the color filter layer 27 and 28 may include a transparent substrate 28 and the red filter 27R, the green filter 27G, and the blue filter 27B formed on the transparent substrate, and the transparent region 27T may be a region in which the red filter 27R, the green filter 27G, and the blue filter 27B are not formed on the transparent substrate 28.

According to one or more embodiments of the present disclosure, the first sub-pixel PR may be configured to selectively emit red light output from the red LED 190R, the second sub-pixel PG may be configured to selectively emit green light output from the green LED 190G, the third sub-pixel PB may be configured to selectively emit blue light output from the blue LED 190B, and the fourth sub-pixel PT may be configured to selectively emit light output from the red LED 190R, the green LED 190G, and the blue LED 190B.

According to one or more embodiments of the present disclosure, a first light-emitting device including the red LED 190R, the green LED 190G, and the blue LED 190B may correspond to a first pixel including the first sub-pixel PR, the second sub-pixel PG, the third sub-pixel PB, and the fourth sub-pixel PT, and the display apparatus 10 may further include a controller configured to control the first light-emitting device and the first pixel.

According to one or more embodiments of the present disclosure, the controller may be configured to open only the first liquid crystal cell 25R and the fourth liquid crystal cell 25T among the first to fourth liquid crystal cells 25R, 25G, 25B, and 25T, in controlling the first light-emitting device to output red monochromatic light.

According to one or more embodiments of the present disclosure, light output efficiency of red light may be improved by opening the fourth liquid crystal cell 25T when outputting red monochromatic light.

According to one or more embodiments of the present disclosure, the controller may be configured to open only the second liquid crystal cell 25G and the fourth liquid crystal cell 25T among the first to fourth liquid crystal cells 25R, 25G, 25B, and 25T, in controlling the first light-emitting device to output green monochromatic light.

According to one or more embodiments of the present disclosure, light output efficiency of green light may be improved by opening the fourth liquid crystal cell 25T when outputting green monochromatic light.

According to one or more embodiments of the present disclosure, the controller may be configured to open only the third liquid crystal cell 25B and the fourth liquid crystal cell 25T among the first to fourth liquid crystal cells 25R, 25G, 25B, and 25T, in controlling the first light-emitting device to output blue monochromatic light.

According to one or more embodiments of the present disclosure, light output efficiency of blue light may be improved by opening the fourth liquid crystal cell 25T when outputting blue monochromatic light.

According to one or more embodiments of the present disclosure, the controller may be configured to open the fourth liquid crystal cell 25T and at least two liquid crystal cells corresponding to a color of mixed light among the first to fourth liquid crystal cells 25R, 25G, 25B, and 25T, in controlling the first light-emitting device to output the mixed light in which at least two of red light, green light, and blue light are mixed.

According to one or more embodiments of the present disclosure, light output efficiency of mixed light may be improved by opening the fourth liquid crystal cell 25T when outputting mixed light.

According to one or more embodiments of the present disclosure, the controller may be configured to determine an opening degree of the first liquid crystal cell 25R, an opening degree of the second liquid crystal cell 25G, and an opening degree of the third liquid crystal cell 25B, respectively, based on a red data value, a green data value, and a blue data value corresponding to the first pixel, and may determine an opening degree of the fourth liquid crystal cell 25T based on the red data value, the green data value, and the blue data value.

According to one or more embodiments of the present disclosure, the controller may be configured to determine a target value that is greater than an average value of the red data value, the green data value, and the blue data value and less than a maximum value among the red data value, the green data value, and the blue data value, and may determine the opening degree of the fourth liquid crystal cell 25T based on the target value.

According to one or more embodiments of the present disclosure, the opening degree of the fourth sub-pixel PT may be appropriately controlled to ensure inter-pixel contrast (or image sharpness) and light efficiency.

According to one or more embodiments of the present disclosure, each of the red LED 190R, the green LED 190G, and the blue LED 190B may be a mini LED having a size of 500 μm × 500 μm or less, and a distributed Bragg reflector (DBR) may be formed on upper and lower surfaces of each of the red LED 190R, the green LED 190G, and the blue LED 190B.

According to one or more embodiments of the present disclosure, the efficiency of light output from light-emitting diodes may be increased.

According to one or more embodiments of the present disclosure, the backlight unit 100 may further include a first optical dome 180R configured to cover the red LED 190R; a second optical dome 180G configured to cover the green LED 190G; and a third optical dome 180B configured to cover the blue LED 190B.

According to one or more embodiments of the present disclosure, an optical dome configured to cover each LED may be provided to improve light emission stability.

According to one or more embodiments of the present disclosure, the backlight unit 100 may further include an optical dome 180 configured to cover all of the red LED 190R, the green LED 190G, and the blue LED 190B.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

Furthermore, the computer-readable recording medium may be provided in the form of a non-transitory storage medium. The term ‘non-transitory storage medium’ may refer to a tangible device without including a signal (e.g., electromagnetic waves) and may not distinguish between storing data in the storage medium semi-permanently and temporarily. For example, the non-transitory storage medium may include a buffer that temporarily stores data.

The method according to the various embodiments disclosed herein may be provided in a computer program product. The computer program product may be traded between a seller and a buyer as a product. The computer program product may be distributed in the form of a machine-readable recording medium (e.g., compact disc read only memory (CD-ROM)), or may be distributed (e.g., download or upload) through an application store (e.g., Play Store^{TM}) online or directly between two user devices (e.g., smartphones). In the case of online distribution, at least a portion of the computer program product (e.g., downloadable app) may be stored at least semi-permanently or may be temporarily generated in a recording medium, such as a memory of a server of a manufacturer, a server of an application store, or a relay server.

One or more embodiments may provide a display apparatus wherein a width of the fourth sub-pixel and a width of a sub-pixel adjacent to the fourth sub-pixel are smaller than a width of another sub-pixel not adjacent to the fourth sub-pixel.

One or more embodiments may provide a display apparatus wherein the fourth sub-pixel is: between the second sub-pixel and the third sub-pixel, between the first sub-pixel and the third sub-pixel, or between the first sub-pixel and the second sub-pixel, and wherein: where the fourth sub-pixel is between the second sub-pixel and the third sub-pixel, a width of the second sub-pixel, a width of the third sub-pixel, and the width of the fourth sub-pixel are smaller than a width of the first sub-pixel, where the fourth sub-pixel is between the first sub-pixel and the third sub-pixel, the width of the first sub-pixel, the width of the third sub-pixel, and the width of the fourth sub-pixel are smaller than the width of the second sub-pixel, and where the fourth sub-pixel is between the first sub-pixel and the second sub-pixel, the width of the first sub-pixel, the width of the second sub-pixel, and the width of the fourth sub-pixel are smaller than the width of the third sub-pixel.

One or more embodiments may provide a display apparatus wherein the one or more pixels includes a first pixel and a second pixel adjacent to the first pixel, and a width of the fourth sub-pixel of the first pixel, a width of the fourth sub-pixel of the second pixel, a width of a sub-pixel adjacent to the fourth sub-pixel of the first pixel, and a width of a sub-pixel adjacent to the fourth sub-pixel of the second pixel are smaller than a width of each sub-pixel of the first pixel and the second pixel that is not adjacent to the fourth sub-pixel of the first pixel or the fourth sub-pixel of the second pixel.

One or more embodiments may provide a display apparatus wherein the red filter, the green filter, and the blue filter are absorption filters that are respectively configured to transmit a specific wavelength band of incident light and absorb remaining wavelength bands.

One or more embodiments may provide a display apparatus wherein the color filter layer further includes a transparent substrate, wherein the red filter, the green filter, and the blue filter are on the transparent substrate, and wherein the transparent region is a region in which the red filter, the green filter, and the blue filter are not present.

One or more embodiments may provide a display apparatus wherein: the first sub-pixel is configured to selectively emit red light output from the red LED, the second sub-pixel is configured to selectively emit green light output from the green LED, the third sub-pixel is configured to selectively emit blue light output from the blue LED, and the fourth sub-pixel is configured to selectively emit light output from the red LED, the green LED, and the blue LED.

One or more embodiments may provide a display apparatus further including a first light-emitting device that includes the red LED, the green LED, and the blue LED, wherein the first light-emitting device corresponds to a first pixel of the one or more pixels, the first pixel including the first sub-pixel, the second sub-pixel, the third sub-pixel, and the fourth sub-pixel, and wherein the display apparatus further includes: a controller configured to control: the first light-emitting device; and the first pixel.

One or more embodiments may provide a display apparatus wherein the controller is further configured to control the first light-emitting device to output red monochromatic light by opening only the first liquid crystal cell and the fourth liquid crystal cell among the first, second, third, and fourth liquid crystal cells.

One or more embodiments may provide a display apparatus wherein the controller is further configured to control the first light-emitting device to output green monochromatic light by opening only the second liquid crystal cell and the fourth liquid crystal cell among the first, second, third, and fourth liquid crystal cells.

One or more embodiments may provide a display apparatus wherein the controller is further configured to control the first light-emitting device to output blue monochromatic light by opening only the third liquid crystal cell and the fourth liquid crystal cell among the first, second, third, and fourth liquid crystal cells, in controlling the first light-emitting device to output blue monochromatic light.

One or more embodiments may provide a display apparatus wherein the controller is further configured to control the first light-emitting device to output mixed light by opening the fourth liquid crystal cell and at least two liquid crystal cells corresponding to a color of the mixed light among the first, second, third, and fourth liquid crystal cells, wherein the mixed light includes at least two of red light, green light, or blue light.

One or more embodiments may provide a display apparatus wherein the controller is further configured to determine: an opening degree of the first liquid crystal cell based on a red data value corresponding to the first pixel; an opening degree of the second liquid crystal cell based on a green data value corresponding to the first pixel; an opening degree of the third liquid crystal cell based on a blue data value corresponding to the first pixel; and an opening degree of the fourth liquid crystal cell based on the red data value, the green data value, and the blue data value.

One or more embodiments may provide a display apparatus wherein the controller is further configured to: determine a target value that is greater than an average value of the red data value, the green data value, and the blue data value and less than a maximum value among the red data value, the green data value, and the blue data value, and determine the opening degree of the fourth liquid crystal cell based on the target value.

Although one or more embodiments of the present disclosure have been described with reference to the accompanying drawings, a person having ordinary skilled in the art will appreciate that other specific modifications may be easily made without departing from the technical spirit or essential features of the present disclosure. Therefore, the foregoing embodiments should be regarded as illustrative rather than limiting in all aspects.

What is claimed is:

1. A display apparatus, comprising:
a backlight unit comprising a red light-emitting diode (LED), a green LED, and a blue LED; and
a liquid crystal panel configured to transmit therethrough light emitted from the backlight unit,
wherein the liquid crystal panel comprises:
a liquid crystal layer comprising liquid crystal cells which are configured to be independently controlled;
a color filter layer on the liquid crystal layer and comprising a red filter, a green filter, a blue filter, and a transparent region; and
one or more pixels, each of the one or more pixels comprising:
a first sub-pixel comprising the red filter and a first liquid crystal cell of the liquid crystal cells;
a second sub-pixel comprising the green filter and a second liquid crystal cell of the liquid crystal cells;
a third sub-pixel comprising the blue filter and a third liquid crystal cell of the liquid crystal cells; and
a fourth sub-pixel comprising the transparent region and a fourth liquid crystal cell of the liquid crystal cells.

2. The display apparatus of claim 1, wherein a width of the fourth sub-pixel and a width of a sub-pixel adjacent to the fourth sub-pixel are smaller than a width of another sub-pixel not adjacent to the fourth sub-pixel.

3. The display apparatus of claim 2, wherein the fourth sub-pixel is:
between the second sub-pixel and the third sub-pixel,
between the first sub-pixel and the third sub-pixel, or
between the first sub-pixel and the second sub-pixel, and wherein:
where the fourth sub-pixel is between the second sub-pixel and the third sub-pixel, a width of the second sub-pixel, a width of the third sub-pixel, and the width of the fourth sub-pixel are smaller than a width of the first sub-pixel,
where the fourth sub-pixel is between the first sub-pixel and the third sub-pixel, the width of the first sub-pixel, the width of the third sub-pixel, and the width of the fourth sub-pixel are smaller than the width of the second sub-pixel, and
where the fourth sub-pixel is between the first sub-pixel and the second sub-pixel, the width of the first sub-pixel, the width of the second sub-pixel, and the width of the fourth sub-pixel are smaller than the width of the third sub-pixel.

4. The display apparatus of claim 1, wherein the one or more pixels comprises a first pixel and a second pixel adjacent to the first pixel, and
a width of the fourth sub-pixel of the first pixel, a width of the fourth sub-pixel of the second pixel, a width of a sub-pixel adjacent to the fourth sub-pixel of the first pixel, and a width of a sub-pixel adjacent to the fourth sub-pixel of the second pixel are smaller than a width of each sub-pixel of the first pixel and the second pixel that is not adjacent to the fourth sub-pixel of the first pixel or the fourth sub-pixel of the second pixel.

5. The display apparatus of claim 1, wherein the red filter, the green filter, and the blue filter are absorption filters that are respectively configured to transmit a specific wavelength band of incident light and absorb remaining wavelength bands.

6. The display apparatus of claim 1, wherein the color filter layer further comprises a transparent substrate,
wherein the red filter, the green filter, and the blue filter are on the transparent substrate, and
wherein the transparent region is a region in which the red filter, the green filter, and the blue filter are not present.

7. The display apparatus of claim 1, wherein:
the first sub-pixel is configured to selectively emit red light output from the red LED,
the second sub-pixel is configured to selectively emit green light output from the green LED,
the third sub-pixel is configured to selectively emit blue light output from the blue LED, and
the fourth sub-pixel is configured to selectively emit light output from the red LED, the green LED, and the blue LED.

8. The display apparatus of claim 1, further comprising a first light-emitting device that includes the red LED, the green LED, and the blue LED,
wherein the first light-emitting device corresponds to a first pixel of the one or more pixels, the first pixel including the first sub-pixel, the second sub-pixel, the third sub-pixel, and the fourth sub-pixel, and
wherein the display apparatus further comprises:
a controller configured to control:
the first light-emitting device; and
the first pixel.

9. The display apparatus of claim 8, wherein the controller is further configured to control the first light-emitting device to output red monochromatic light by opening only the first liquid crystal cell and the fourth liquid crystal cell among the first, second, third, and fourth liquid crystal cells.

10. The display apparatus of claim 8, wherein the controller is further configured to control the first light-emitting device to output green monochromatic light by opening only the second liquid crystal cell and the fourth liquid crystal cell among the first, second, third, and fourth liquid crystal cells.

11. The display apparatus of claim 8, wherein the controller is further configured to control the first light-emitting device to output blue monochromatic light by opening only the third liquid crystal cell and the fourth liquid crystal cell among the first, second, third, and fourth liquid crystal cells, in controlling the first light-emitting device to output blue monochromatic light.

12. The display apparatus of claim 8, wherein the controller is further configured to control the first light-emitting device to output mixed light by opening the fourth liquid crystal cell and at least two liquid crystal cells corresponding to a color of the mixed light among the first, second, third, and fourth liquid crystal cells,
wherein the mixed light comprises at least two of red light, green light, or blue light.

13. The display apparatus of claim 8, wherein the controller is further configured to determine:
an opening degree of the first liquid crystal cell based on a red data value corresponding to the first pixel;
an opening degree of the second liquid crystal cell based on a green data value corresponding to the first pixel;
an opening degree of the third liquid crystal cell based on a blue data value corresponding to the first pixel; and
an opening degree of the fourth liquid crystal cell based on the red data value, the green data value, and the blue data value.

14. The display apparatus of claim 13, wherein the controller is further configured to:
determine a target value that is greater than an average value of the red data value, the green data value, and the blue data value and less than a maximum value among the red data value, the green data value, and the blue data value, and
determine the opening degree of the fourth liquid crystal cell based on the target value.
